(19) United States
(12) Patent Application Publication
(10) Pub. No.: US 2026/0113064 A1
(43) Pub. Date: Apr. 23, 2026

(54) SYSTEM, INTER-BASE STATION CONTROL METHOD AND PROGRAM

(71) Applicant: SoftBank Corp., Tokyo (JP)

(72) Inventors: Takuya Kaneda, Tokyo (JP); Teruya Fujii, Tokyo (JP)

(73) Assignee: SoftBank Corp., Tokyo (JP)

(21) Appl. No.: 19/153,629

(22) PCT Filed: Dec. 5, 2023
(86) PCT No.: PCT/JP2023/043539

§ 371 Date: Aug. 5, 2025

(30) Foreign Application Priority Data
Feb. 7, 2023 (JP) 2023-017169

(51) Int. Cl. H04B 1/10

(52) U.S. Cl. CPC H04B 1/10

(57) ABSTRACT

In a configuration of plural HetNets disposed in a cellular manner, in which each HetNet is configured with one or plural small-sized second cells are disposed in a first cell, are, a system capable of suppressing an interference in an uplink in the HetNet and between HetNets is provided. The system is provided with a plurality of first-stage interference suppression apparatuses for suppressing an uplink interference signal from a terminal located in the second cell to an uplink reception signal of a first base station of the first cell of the HetNet, in each of the plural HetNets, and a second-stage interference suppression apparatus for suppressing an uplink interference signal to an uplink reception signal of a first base station in a first cell of one HetNet after performing the suppression of the interference signal by the first-stage interference suppression apparatus, from a terminal located in a first cell of other HetNet, with respect to each of the plural HetNets.

### TECHNICAL FIELD

The present invention relates to an interference suppression technology in a heterogeneous cellular network (HetNet) configuration of different-kind cell size mixture type.

### BACKGROUND ART

In order to support a rapid increase in traffic in a mobile communication system in recent years, there is a growing demand for a small-cell base station (also called “tiny-cell base station”, “pico-cell base station”, “femto-cell base station”, etc.), which has a smaller cell (radio communication area) than conventional macro-cell base stations. For example, in an urban area, in order to support a localized sudden increase in traffic inside mid-rise and high-rise buildings (large offices), a three-dimensional spatial cell configuration (3D HetNet configuration), which is configured by disposing a small cell on each floor of the mid-rise and high-rise buildings located within a macro cell on the ground, is attracting attention (see Non-Patent Literatures 1, 2, and 3). In particular, when the macro cell and the small cell use the same frequency, an interference between the macro cell and the small cell and an interference between the small cells becomes a problem compared to a two-dimensional spatial HetNet configuration in which small cells are disposed on the ground, and it is necessary to avoid or suppress the interferences.

Non-Patent Literature 4 discloses a “Received Interference Canceller by using a Cooperative Network of Macro-Cell Base Station” as a countermeasure against an uplink interference in the three-dimensional spatial HetNet configuration, in which a macro cell and each small cell work together to suppress the uplink interference from terminal located in the small cell to the macro-cell base station, at the macro-cell base station. This received interference canceller is a linear interference canceller that generates a replica signal to remove each small-cell interference signal at the macro-cell base station, based on the reception signal of each small-cell base station, within the same resource block, and subtracts the replica signal from the reception signal of the macro-cell base station.

### CITATION LIST

### Non-Patent Literature

[Non-Patent Literature 1] A. Nagate, M. Mikami, T. Okamawari, T. Fujii, “Layered Cell Configuration for 3D Dense Cell Structure”, International Workshop on Smart Wireless Communications (SmartCom2016), vol. 116, no. 29, SR2016-5, pp. 9-14, Oulu, Finland, May 2016.
[Non-Patent Literature 2] A. Nagate, S. Nabatame, K. Hoshino and T. Fujii, “Experimental Evaluations of Coordinated Interference Control for Co-channel Overlaid Cell Structure”, Proceedings of IEEE VTC2015-Spring, Glasgow, May 2015.
[Non-Patent Literature 3] T. Okamawari, S. Shiobara, Y. Nagai and T. Fujii, “Field evaluation of eICIC using highly accurate GPS based synchronization scheme”, Proceedings of IEEE VTC2015-fall, Boston, USA, September 2015.
[Non-Patent Literature 4] Takuya Kaneda, Teruya Fujii, “Uplink Interference Canceller by using Cooperative Control Network in HetNet Configuration,” Transactions of the Institute of Electronics, Information and Communication Engineers, B, Vol. J104-B, No. 8, pp. 723-726.

### SUMMARY OF INVENTION

### Technical Problem

The above-mentioned conventional received interference canceller has a problem in that it is not possible to suppress an uplink interference between HetNets in a configuration in which the configuration of plural HetNets using the same frequency band is expanded into a cellular-like configuration (hereinafter also referred to as a “plural-HetNet configuration” or a “HetNet cellular configuration”). For example, the antenna of the macro-cell base station of the HetNet receives not only uplink signals from terminals located in the small cells of the HetNet, but also uplink signals from terminals located in macro cells of surrounding HetNets as interference signals. The above-mentioned conventional received interference canceller has a problem in that it is not possible to suppress both the interference signals of the uplink within the HetNet and the interference signals in the uplink between the HetNets.

### Solution to Problem

A system according to an aspect of the present invention is a system for suppressing an interference from a terminal to a base station in a plural-HetNet configuration in which plural HetNets (heterogeneous networks) using a same frequency band including a first cell formed by a first base station and one or plural second cells formed in the first cell by one or plural second base stations are disposed in a cellular manner. This system comprises a plurality of first-stage interference suppression apparatuses that suppress an uplink interference signal from a terminal located in the second cell to an uplink reception signal of the first base station of the first cell of the HetNet, in each of the plural HetNets, and a second-stage interference suppression apparatus that suppresses an uplink interference signal to an uplink reception signal of a first base station in a first cell of one HetNet after performing the suppression of the interference signal by the first-stage interference suppression apparatus, from a terminal located in a first cell of other HetNet, with respect to each of the plural HetNets.

In the foregoing system, each of the plurality of the first-stage interference suppression apparatuses may comprise a first-stage matrix creation section that estimates a first-propagation path response from the terminal located in the second cell to an antenna of the first base station of the first cell, creates a first-propagation path response matrix including the first-propagation path response as an element, estimates a second-propagation path response from the terminal located in the second cell to an antenna of the second base station of the second cell, and creates a second-propagation path response matrix including the second-propagation path response as an element, a first-stage weight calculation section that calculates an inverse matrix of the second-propagation path response matrix, and calculates a first-stage reception weight to be applied to a reception signal received by the antenna of the second base station of the second cell based on the inverse matrix of the second-propagation path response matrix and the first-propagation path response matrix, and a first-stage reception signal processing section that suppresses an interference of the uplink interference signal from the terminal located in the second cell to the uplink reception signal of the first base station of the first cell, based on the reception signal received by the antenna of the first base station of the first cell, the plural reception signals received by the antenna of the second base station of the second cell, and the first-stage reception weight. Furthermore, in the foregoing system, the second-stage interference suppression apparatus may comprise a second-stage matrix creation section that estimates a third-propagation path response from the terminal located in the first cell of the other HetNet to the antenna of the first base station of the first cell of the one HetNet, creates a third-propagation path response matrix including the third-propagation path response as an element, estimates a fourth-propagation path response from the terminal located in the first cell of the other HetNet to the antenna of the first base station of the first cell of the other HetNet, and creates a fourth-propagation path response matrix including the fourth-propagation path response as an element, a second-stage weight calculation section that calculates an inverse matrix of the fourth-propagation path response matrix, and calculates a second-stage reception weight to be applied to the reception signal received by the antenna of the first base station of the first cell of the other HetNet, based on the inverse matrix of the fourth-propagation path response matrix and the third-propagation path response matrix, and a second-stage reception signal processing section that suppresses an interference of the uplink interference signal from the terminal located in the first cell of the other HetNet to the uplink reception signal of the first base station of the first cell of the one HetNet, based on the reception signal received by the antenna of the first base station of the first cell of the one HetNet, the reception signal received by the antenna of the first base station of the first cell of the other HetNet, and the second-stage reception weight.

In the foregoing system, the number of the HetNets may be two or more, and the second-stage matrix creation section may set to zero a fourth-propagation path response having an electric power of magnitude equal to or less than a predetermined threshold value, or less than the threshold value, among the plural fourth-propagation path responses included in the fourth-propagation path response matrix before calculating the inverse matrix.

In the foregoing system, the second-stage matrix creation section may calculate the electric power of each of the plural fourth-propagation path responses included in the fourth-propagation path response matrix before calculating the inverse matrix, and correct to zero a fourth propagation path response in which the calculated value of the electric power is equal to or less than a predetermined threshold value γₜₕ, or less than the threshold value γₜₕ.

In the foregoing system, the system may set to zero in advance a fourth-propagation path response that is expected to have a small contribution to the interference among the plural fourth-propagation path responses of the fourth-propagation path response matrix created by the second-stage matrix creation section, and the second-stage matrix creation section may not estimate the fourth-propagation path response that is set to zero in advance among the plural fourth-propagation path responses of the fourth-propagation path response matrix, and correct to zero a fourth-propagation path response in which the calculated value of the electric power of the fourth-propagation path response is equal to or less than a predetermined threshold value Γₜₕ, or less than the threshold value Γₜₕ, among the plural fourth-propagation path responses that are not set to zero in advance.

In the foregoing system, the system may set to zero in advance a fourth-propagation path response that is expected to have a small contribution to the interference among the plural fourth-propagation path responses of the fourth-propagation path response matrix created by the second-stage matrix creation section, and the second-stage matrix creation section may not estimate the fourth-propagation path response that is set to zero in advance among the plural fourth-propagation path responses of the fourth-propagation path response matrix.

In the foregoing system, the system may estimate the plural fourth-propagation path responses before starting an operation of the plural first base stations, and may set to zero a fourth-propagation path response in which the calculated value of the electric power of the fourth-propagation path response is equal to or less than the predetermined threshold value Γₜₕ, or less than the threshold value Γₜₕ, among the plural fourth-propagation path responses.

In the foregoing system, the system may determine a fourth-propagation path response to be set to zero in advance based on a positional relationship between the plural first base stations or a positional relationship between the plural first cells in the plural HetNets.

In the foregoing system, the system may not suppress the interference signal by the first-stage interference suppression apparatus, when the electric power of the uplink interference signal from the terminal located in the second cell to the uplink reception signal of the first base station of the first cell of the HetNet is equal to or less than a predetermined threshold value, or less than the threshold value, in each of the plural HetNets.

In the foregoing system, the first cell may be a macro cell and the second cell may be a small cell.

### Advantageous Effects of Invention

According to the present invention, in a configuration of plural HetNets disposed in a cellular manner, in which each HetNet is configured with one or plural small-sized second cells are disposed in a first cell it is possible to suppress an interference from the terminal located in the second cell to an uplink reception signal received by the antenna of the base station of the first cell in the HetNet, and it is also possible to suppress an interference from the terminal located in the first cell of a surrounding HetNet to an uplink reception signal received by the antenna of the base station of the first cell of the HetNet.

### BRIEF DESCRIPTION OF DRAWINGS

FIG. 1 is a diagram showing an example of a HetNet configuration provided in a plural-HetNet configuration to which a system according to an embodiment can be applied.

FIG. 2 is a diagram showing an example of a state in which interference arrives from surrounding terminals at a macro-cell base station (first base station) that forms a macro cell (first cell) of a central HetNet in the plural-HetNet configuration.

FIG. 3 is a diagram showing an example of a system using a cooperative control network having an uplink interference canceller function of each of the plural HetNets provided in the plural-HetNet configuration according to the embodiment.

FIG. 4 is a diagram showing an example of a configuration of a system having a function of a received interference canceller of a base station in a single HetNet included in the plural-HetNet configuration according to the embodiment.

FIG. 5 is an illustration showing an example of the plural-HetNet configuration according to the embodiment.

FIG. 6 is an illustration showing an example of a model of signals in the plural-HetNet configuration according to the embodiment.

FIG. 7 is a diagram showing a configuration example of a system having a function of a received interference canceller for plural base stations in the plural-HetNet configuration according to the embodiment.

FIG. 8 is a diagram showing an example of a first-stage interference suppression apparatus (received interference canceller) in the system of FIG. 7.

FIG. 9 is a diagram showing an example of an application effect of the first-stage interference suppression apparatus (received interference canceller).

FIG. 10 is a diagram showing an example of a second-stage interference suppression apparatus (received interference canceller) in the system of FIG. 7.

FIG. 11 is a diagram showing an example of an application effect of the first-stage interference suppression apparatus (received interference canceller) and the second-stage interference suppression apparatus (received interference canceller) in the plural-HetNet configuration of the system according to the embodiment.

FIG. 12A is a diagram showing an example of the plural-HetNet configuration when the number of surrounding macro cells N_{M} is 6.

FIG. 12B is a diagram showing an example of the plural-HetNet configuration when the number of surrounding macro cells N_{M} is 18.

FIG. 13A is a diagram showing an example of transmission and reception of a signal from the terminal to the antenna of the macro-cell base station when the macro cells are close to each other in a first-signal processing amount reduction method of the second-stage interference suppression apparatus (received interference canceller) of the system according to the embodiment.

FIG. 13B is a diagram showing an example of transmission and reception of a signal from the terminal to the antenna of the macro-cell base station when the macro cells are far apart in the first-signal processing amount reduction method.

FIG. 14A is a diagram showing a specific example of an approximation of a propagation path response hⱼᵢ^{M} when a first threshold value γₜₕ^{M} is set in the first-signal processing amount reduction method.

FIG. 14B is a diagram showing a specific example of approximation of the propagation path response hⱼᵢ^{M} when another different first threshold value γₜₕ^{M} is set in the first-signal processing amount reduction method.

FIG. 14C is a diagram showing a specific example of an approximation of the propagation path response hⱼᵢ^{M} when yet another different first threshold value γₜₕ^{M} is set in the first-signal processing amount reduction method.

FIG. 15A is a diagram showing an example of transmission and reception of a signal from the terminal to the antenna of the macro-cell base station when the macro cells are close to each other in a second-signal processing amount reduction method of the second-stage interference suppression apparatus (received interference canceller) of the system according to the embodiment.

FIG. 15B is a diagram showing an example of transmission and reception of a signal from the terminal to the antenna of the macro-cell base station when the macro cells are far apart in the second-signal processing amount reduction method.

FIG. 16A is a diagram showing a specific example of a presetting of the propagation path response hⱼᵢ^{M} when the second threshold value Γₜₕ^{M} is set in the second-signal processing amount reduction method.

FIG. 16B is a diagram showing a specific example of the presetting of the propagation path response hⱼᵢ^{M} when another different second threshold value Γₜₕ^{M} is set in the second-signal processing amount reduction method.

FIG. 16C is a diagram showing a specific example of the presetting of the propagation path response hⱼᵢ^{M} when yet another different second threshold value Γₜₕ^{M} is set in the second-signal processing amount reduction method.

FIG. 16D FIG. 16C is a diagram showing a specific example of the presetting of the propagation path response hⱼᵢ^{M} when yet another different second threshold value Γₜₕ^{M} is set in the second-signal processing amount reduction method.

FIG. 17 is a diagram showing an example of a state in which an interference arrives at the macro-cell base station from a terminal of a surrounding small cell in the HetNet configuration.

FIG. 18A is a diagram showing an example of transmission and reception of a signal from the small cell terminal to the antenna of the macro-cell base station when the small cell and the antenna of the macro-cell base station are close to each other in the system according to the embodiment.

FIG. 18B is a diagram showing an example of transmission and reception of a signal from the small cell terminal to the antenna of the macro-cell base station when the small cell and the antenna of the macro-cell base station are far apart.

FIG. 19 is a diagram showing an example of processing by the first-stage interference suppression apparatus (received interference canceller) when the interference from the small cell terminal to the antenna of the macro-cell base station is small in the system according to the embodiment.

FIG. 20 is a block diagram showing an example of the configuration of the first-stage interference suppression apparatus in the system according to the embodiment.

FIG. 21 is a block diagram showing an example of the configuration of the second-stage interference suppression apparatus in the system according to the embodiment.

### DESCRIPTION OF EMBODIMENTS

Hereinafter, various embodiments of the present invention are described with reference to the drawings. It should be noted that each drawing merely shows a schematic representation of the shape, size and positional relationship to the extent that the contents of the present invention can be understood, and therefore the present invention is not limited to only the shape, size and positional relationship exemplified in each drawing. Furthermore, the numerical values exemplified below are merely preferred examples of the present invention, and therefore the present invention is not limited to the exemplified numerical values.

The system disclosed as an example of the embodiment in the present specification is a system that is provided with plural-stage network-cooperative uplink interference cancellers that suppress an interference on an uplink from a terminal to a base station, in the plural-HetNet configuration (HetNet cellular configuration) in which plural heterogeneous cellular network (HetNet) configurations (for example, HetNet configurations in two-dimensional space, or HetNet configurations expanded into three-dimensional space) of mixture type of different cell sizes with high-frequency utilization efficiency, configured by installing one or plural second cells (small cells) using the same frequency band in a first cell (macro-cell), are disposed in a cellular manner. In particular, the system according to the embodiment of the present disclosure is provided with a plurality of first-stage interference suppression apparatuses (interference cancellers) and a second-stage interference suppression apparatus (interference canceller). In each of the plural HetNets, a plurality of first-stage interference suppression apparatuses (interference cancellers) suppress an uplink interference signal from a terminal located in a second cell (small cell) to uplink reception signal of a first base station (macro-cell base station) in a first cell (macro-cell) of the HetNet. The second-stage interference suppression apparatus (interference canceller) suppresses, for each of the plural HetNets, an uplink interference signal to an uplink reception signal of a first base station (macro-cell base station) in a first cell (macro-cell) of one HetNet from a terminal located in a first cell (macro-cell) of other HetNet, after the interference signal is suppressed by the first-stage interference suppression apparatus (interference canceller).

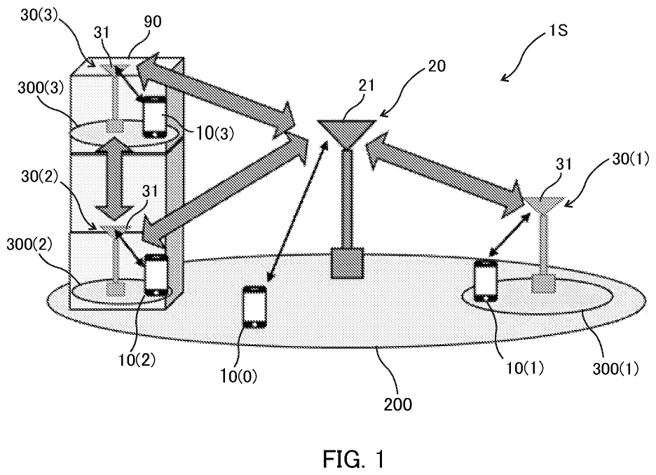

FIG. 1 is a diagram showing an example of a configuration of a HetNet provided in a plural-HetNet configuration to which the system according to an embodiment can be applied. In FIG. 1, the system of the present embodiment is provided with, as plural base stations (referred to as “eNodeB”, “eNB”, “gNodeB”, “gNB”, etc.) for mobile communications, a macro-cell base station 20 as a first-cell base station that forms a macro cell 200 as a first cell, and plural small-cell base stations 30(1) to 30(3) as a plurality of second base stations that respectively form small cells 300(1) to 300(3) as plural second cells having a smaller cell size than the macro cell 200. The macro-cell base station 20 can wirelessly communicate with a terminal 10(0) located in the macro cell 200 via an antenna 21. In the macro cell 200 of the macro-cell base station 20, at least an antenna 31 of each of the plural small-cell base stations 30(1) to 30(3) is disposed. Each of the plural small-cell base stations 30(1) to 30(3) can wirelessly communicate with terminals 10(1) to 10(3) respectively located in the small cells 300(1) to 300(3), via an antenna 31.

The configuration in FIG. 1 is a “HetNet configuration” that is effective as a traffic countermeasure, in which small cells 300(1) to 300(3) are respectively disposed in areas where a lot of traffic is concentrated, such as hot spots, etc. in the macro cell 200. In the present system, the macro cell and the small cells use the same frequency. In particular, in an urban area where a building 90 shown in FIG. 1 stands side by side, there are many cases where traffic often occurs concentratedly in a large office on a high floor, and a “three-dimensional space of HetNet configuration (three-dimensional space cell configuration)” is extremely effective, in which small cells are disposed in such locations described above. In the three-dimensional space cell configuration of FIG. 1, the outdoor small cell 300(1) is disposed in a horizontal planar direction, and the plural indoor small cells 300(2) and 300(3) are disposed in vertical height direction. It is noted that in the configuration of FIG. 1, the number of small cells 300 may be one, or may be two, four or more.

In the HetNet configuration, it is capable of stabilizing the overall communication quality by respectively disposing the small cells 300(1) to 300(3) in locations with particularly high communications traffic in the macro cell 200 of performing wide-area communications.

It is noted that, in FIG. 1, the number of macro-cell base stations and the number of small-cell base stations are arbitrary. For example, the macro-cell base station may be provided in two or more locations, and the small-cell base station may be provided in one location, or in plural locations such as two locations, four locations or more, in the macro cell. Furthermore, the macro-cell base station and the small-cell base station are controlled to time-synchronize with each other.

The macro-cell base station 20 is a wide-area base station installed outdoors in a mobile communication network and covers a macro cell that is a wide area usually having a radius of several hundred meters to several kilometers. The macro-cell base station 20 is connected to a core network of the mobile communication network via a line termination apparatus and a communication line such as an optical line, a dedicated line, etc., and is capable of communicating with various nodes such as server apparatuses on the core network, etc. via a predetermined communication interface.

Unlike a wide-area macro cell base station, each of the small-cell base stations 30(1) to 30(3) is a small-capacity base station that can perform radio communications over a distance of, for example, several tens to several hundreds of meters, and can be installed indoors, such as in an ordinary home, store, office, etc. The small-cell base stations 30(1) to 30(3) are provided to cover an area smaller than the area covered by a wide-area macro cell base station in the mobile communication network. The small-cell base stations 30(1) to 30(3) are connected to the core network of the mobile communication network via a line termination apparatus and a communication line such as an optical line, a dedicated line, etc., and can communicate with various nodes such as server apparatuses on the core network, etc. via a predetermined communication interface.

The same radio transmission method and the same frequency band are used for radio communications between the terminals and each of the macro-cell base station 20 and the small-cell base stations 30(1) to 30(3). By using the same frequency band, it is possible not to compress the frequency band compared to when different frequency bands are used between the macro cell and the small cell.

As a radio transmission method, for example, a communication method such as LTE (Long Term Evolution) or LTE-Advanced, a communication method of the 4th-generation mobile phone, or a communication method of next generation mobile phone such as the 5th generation or the 6th generation, etc. can be adopted.

The terminal 10 is a mobile phone, a smartphone, a portable personal computer with a mobile communication function, or the like, and is also called user equipment (UE), a mobile station, a mobile device, or a portable communication terminal. The terminal 10(0) is located in the macro cell 200 and communicates with the mobile communication network side via the macro-cell base station 20 corresponding to the macro cell 200. Furthermore, each of the terminals 10(1) to 10(3) is located in the small cells 300(1) to 300(3) and respectively communicates with the mobile communication network side via small-cell base stations 30(1) to 30(3).

The terminal 10 is configured using, for example, hardware such as a computer apparatus having a CPU, memory, etc., a radio communication section, or the like, and can perform radio communications with the macro-cell base station 20 and the small-cell base stations 30(1) to 30(3) by executing a predetermined program. In addition, each of the macro-cell base station 20 and the small-cell base stations 30(1) to 30(3) is configured using, for example, hardware such as a computer apparatus having a CPU, memory, etc., an external-communication interface section for the core network, a radio communication section, or the like, and can perform a radio communication with the terminal 10 and a communication with the core network side by executing a predetermined program.

The terminal 10 may be a modular mobile station incorporated in a moving object such as an automobile or a drone, etc., or may be a terminal apparatus for an IoT (Internet of Things) device.

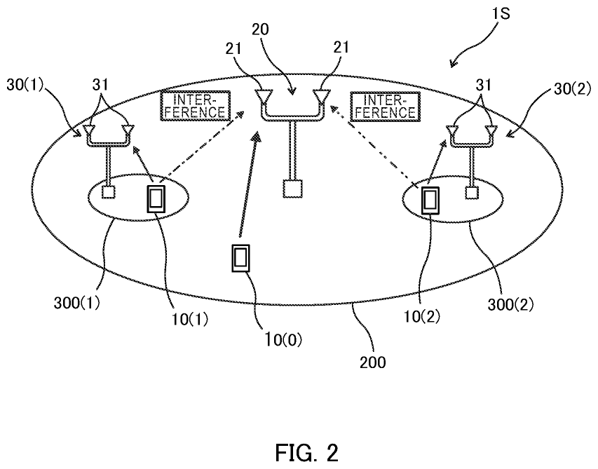

FIG. 2 is a diagram showing an example of a state of interference arriving from surrounding terminals at a macro-cell base station (first base station) that forms the macro cell (first cell) of the central HetNet in the plural-HetNet configuration (HetNet cellular configuration) in which the HetNets of FIG. 1 are disposed in a cellular manner. In FIG. 2, as shown by the solid lines in the figure, the macro cell terminal 10(0) communicates with the macro-cell base station 20, and each of the small cell terminals 10(1) and 10(2) communicates with each of the small-cell base stations 30(1) and 30(2). However, as shown by the dashed line and the chain double-dashed line in the figure, signals transmitted from terminals 10(1) and 10(2) located in the small cells 300(1) and 300(2) may reach the antenna 21 of the macro-cell base station 20, causing an interference with the uplink of the macro cell by the signals from the small cells, which may result in degradation of communication quality of the macro cell. In particular, in the HetNet configuration of the three-dimensional space exemplified in FIG. 1, as shown by the arrows in the figure, it is extremely complicated to estimate a giving interference and a receiving interference between the cells. In addition, it is extremely difficult to construct the three-dimensional space cell configuration capable of avoiding a mutual interference by keeping a spatial separation distance between the cells. In order to realize the three-dimensional space cell configuration, an advanced interference control is essentially needed.

In order to avoid an interference with the uplink of the macro cell, it is considerable of a method of reducing the transmission power of the terminals 10(1) and 10(2) located in the small cells 300(1) and 300(2). However, this method results in a decrease of communication quality in the small cells 300(1) and 300(2).

Furthermore, as an inter-cell interference control technology applicable to the HetNet configuration, it is known of an inter-cell interference control technology called an eICIC (enhanced Inter Cell Interference Coordination) that complies with the above-mentioned LTE-Advanced standard. In this inter-cell interference control technology (eICIC), radio resources in the same frequency band are time-divided and time slots different from each other are allocated to transmissions from the respective terminals in the macro cell and small cell, thereby making it possible to avoid an interference in the same frequency band between the macro cell and the small cell. However, in the inter-cell interference control technology (eICIC), radio resources (time slots) are divided in each of the macro cell and small cell, and a part of each radio resource is not used by each other. As a result, each base station cannot use the entire band of radio resources (time slots), and the maximum transmission rate (peak throughput) of the macro cell and small cell decreases.

In the system of the present embodiment, as a countermeasure against uplink interference in the HetNet configuration provided in the plural-HetNet configuration, the system is provided with the function of an “uplink interference canceller”, which is an interference suppression apparatus that suppresses an uplink interference using a “cooperative control network” in which the macro cells and the small cells work together to perform a cooperative control.

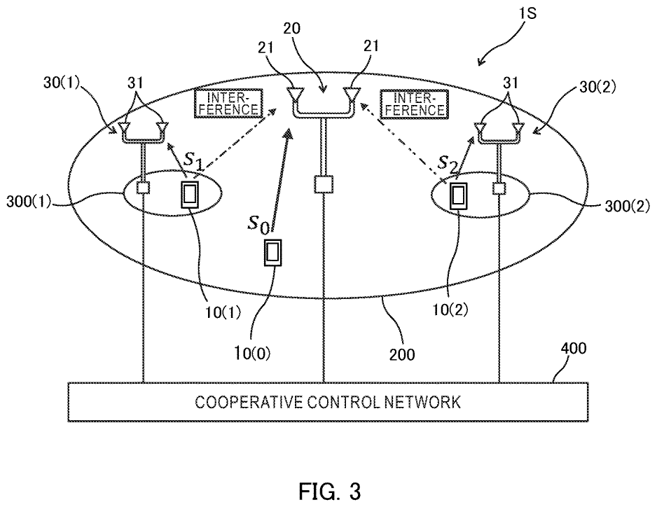

FIG. 3 is a diagram showing an example of a system using a cooperative control network 400 having the function of the uplink interference canceller for each of the plural HetNets provided in the plural-HetNet configuration according to the embodiment. In FIG. 3, at the antenna 21 of the macro-cell base station 20, a desired signal (component s0) of the uplink transmitted from the macro cell terminal 10(0) arrives, and uplink signals transmitted from the small cell terminals 10(1) and 10(2) arrive as interference signals (components s1 and s2). When the interference signals s1 and s2 interfere with the desired signal s0, the communication quality of the uplink in the macro-cell base station 20 (macro cell uplink) deteriorates.

The system of the present embodiment is provided with the cooperative control network 400 having a function of macro-cell uplink interference canceller in each of the plural HetNets, thereby making it possible to prevent a degradation of communication quality in the macro cell uplink due to the interference signal from the small cell. In the macro-cell uplink interference canceller, in the cooperative control network 400 connected to each of the base stations 20, 30(1) and 30(2), an interference cancellation weight (reception weight) is superimposed on the reception signal of each of the small-cell base stations 30(1) and 30(2) and subtracted from the reception signal of the macro-cell base station 20 (by adding in reverse phase to the interference signal component of the reception signal of the macro-cell base station 20), thereby suppressing an uplink interference in the macro-cell base station 20. In other words, the macro-cell uplink interference canceller of the embodiment is a linear interference canceller that generates a replica signal for removing an interference signal from each small cell in the macro-cell base station 20, based on the reception signal of each of the small-cell base station 30(1) and 30(2) and subtracts the replica signal from the reception signal of the macro-cell base station 20, thereby achieving a significant interference suppression effect. [Basic configuration of uplink reception canceller in a single HetNet]

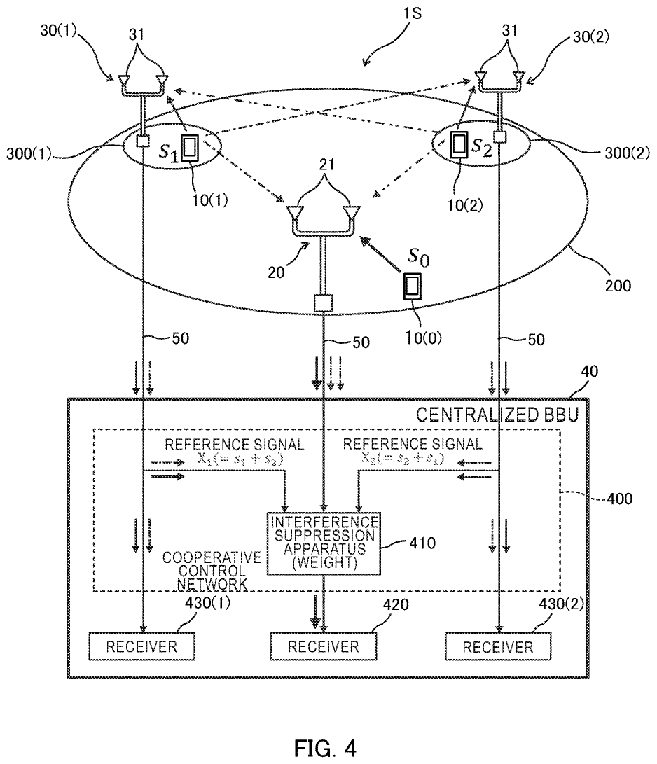

FIG. 4 is a diagram showing an example of a configuration of a system having a function of a received interference canceller of a base station in a single HetNet in the plural-HetNet configuration according to the embodiment. It is noted that, although the mobile communication system in FIG. 4 shows an example based on a C-RAN (Centralized-Radio Access Network) configuration, it may also be a mobile communication system with other configurations such as a D-RAN (Distributed-Radio Access Network), etc.

In FIG. 4, each of the macro-cell base station 20 and the small-cell base stations 30(1) and 30(2) is provided with an RRH (Remote Radio Header) (also called an “remote-type base station” or “optical remote-type base station”) and a BBU (Base Band Unit) that includes a base-band signal processing section, a receiver and a transmitter, where the RRH and the BBU are connected to each other via a communication line 50 such as a wired communication line or a radio communication line such as a broadband optical fiber or an inter-base station interface (for example, x2 interface in the LTE), etc. The BBU of each of the base stations 20, 30(1) and 30(2) is aggregated in a centralized BBU 40, which is a common base-band processing section installed in one location. The RRH of each of the base stations 20, 30(1) and 30(2) is provided, for example, near the antennas 21 and 31, and is connected to the centralized BBU 40 via the communication line 50, and is further connected to each of the receiver 420, 430(1) and 430(2) via a cooperative control network 400 in the centralized BBU 40. The RRH of each base station converts a transmission signal from the centralized BBU 40 into a radio signal and transmits it from the antennas 21 and 31 with a predetermined transmission power, and converts a radio signal received by the antennas 21 and 31 into a reception signal and transmits it to the centralized BBU 40. The cooperative control network 400 in the centralized BBU 40 can implement a first-stage macro cell uplink received interference canceller and a small-cell uplink received interference canceller, which are described later.

The difference in propagation distance and the difference in signal processing time between each of the base stations 20, 30(1) and 30(2) and the centralized BBU 40 can be compensated by a digital signal processing in the centralized BBU 40.

An interference suppression apparatus (received interference canceller) 410 in the HetNet in FIG. 4 utilizes the fact that interference signals (components S1 and S2) among the reception signals of the macro-cell base station 20 are included in the reception signals of each of the small cell base stations 30(1) and 30(2). In FIG. 4, for example, the reception quality (SINR characteristic) of the macro-cell base station 20 deteriorates due to the interference signals S1 and S2 from the terminals 10(1) and 10(2) located in the small cells 300(1) and 300(2). In order to suppress (cancel) the interference signals from the terminals 10(1) and 10(2), the interference suppression apparatus 410 transfers reception signals X1 and X2 of the macro-cell base station 20 and the small-cell base stations 30(1) and 30(2) to the cooperative control network 400 in the centralized BBU 40, superimposes interference cancellation weights (hereinafter also referred to as “reception weights” or “weights”) w₁^{C} and w₂^{C} on these signals, and generates a signal (hereinafter also referred to as an “interference cancellation signal”) that serves as an interference signal replica of the macro-cell base station 20 using the signal superimposed with the weights w₁^{C} and w₂^{C}. The interference suppression apparatus 410 executes a received-interference canceller process for subtracting the interference cancellation signal from a reception signal X0 of the macro-cell base station 20. This makes it possible to suppress the interference in the uplink of the macro-cell base station 20.

The interference cancellation weight used in the interference suppression apparatus 410 in the single HetNet can be obtained, for example, by the following steps (1) to (4).

(1) Each of the plural small-cell base stations 30 measures the propagation path response from terminals 10(1), 10(2), . . . that are located in the other small cells 300. For example, if the number of small cells is Ns, each small-cell base station 30 needs to measure Ns propagation path responses.

(2) The interference suppression apparatus 410 collects the propagation path responses hⱼᵢ between the small cells 300 to generate a propagation-path response matrix H. It is noted that the propagation path responses between the terminal 10(i) and the base station 30(j) are denoted as hⱼᵢ. For example, if the number of small cells Ns is four (Ns=4), then the propagation-path response matrix H of the following equation (1) is generated.

$$H = [ \begin{matrix}{h}_{11} & {h}_{21} & {h}_{31} & {h}_{41} \\ {h}_{12} & {h}_{22} & {h}_{32} & {h}_{42} \\ {h}_{13} & {h}_{23} & {h}_{33} & {h}_{43} \\ {h}_{14} & {h}_{24} & {h}_{34} & {h}_{44}\end{matrix} ] \qquad ( 1 )$$

(3) Furthermore, the interference suppression apparatus 410 collects the propagation path responses hoi from the terminals 10(1), 10(2), . . . that are located in the small cell 300 to the macro-cell base station 20 to generate a propagation-path response matrix h0. For example, if the number of small cells Ns is four (Ns=4), then the propagation-path response matrix h0 of the following equation (2) is generated.

$${h}_{0} = [ \begin{matrix}{h}_{01} \\ {h}_{02} \\ {h}_{03} \\ {h}_{04}\end{matrix} ] \qquad ( 2 )$$

(4) The interference suppression apparatus 410 determines the interference cancellation weight W^{C} by the following equation (3) using the propagation-path response matrix H between the small cells and the propagation path response hoi from the small cell to the macro cell. For example, if the number of small cells Ns is four (Ns=4), the interference cancellation weight W^{C} is determined by the following equation (4).

$${W}^{c} = - {H}^{- 1} {h}_{0} \qquad ( 3 )$$

$$[ \begin{matrix}{W}_{1}^{C} \\ {W}_{2}^{C} \\ {W}_{3}^{C} \\ {W}_{4}^{C}\end{matrix} ] = {[ \begin{matrix}{h}_{11} & {h}_{21} & {h}_{31} & {h}_{41} \\ {h}_{12} & {h}_{22} & {h}_{32} & {h}_{42} \\ {h}_{13} & {h}_{23} & {h}_{33} & {h}_{43} \\ {h}_{14} & {h}_{24} & {h}_{34} & {h}_{44}\end{matrix} ]}^{- 1} [ \begin{matrix}{h}_{01} \\ {h}_{02} \\ {h}_{03} \\ {h}_{04}\end{matrix} ] \qquad ( 4 )$$

A reception signal S0 after interference cancellation in which the interference is suppressed using the interference cancellation weight W^{C} can be expressed by the following equation (5). Herein, in the equation (5), x0 represents the reception signal of the macro-cell base station 20, X represents the matrix of the reference signal transferred from each small-cell base station to the interference suppression apparatus 410 via the communication line 50, and T represents the transpose.

$${x}_{0} + {( {W}^{C} )}^{T} X = {s}_{0} \qquad ( 5 )$$

Next, a description is given of a suppression of interference between cells in the plural-HetNet configuration (HetNet cellular configuration) in which plural HetNets are disposed in a cellular manner.

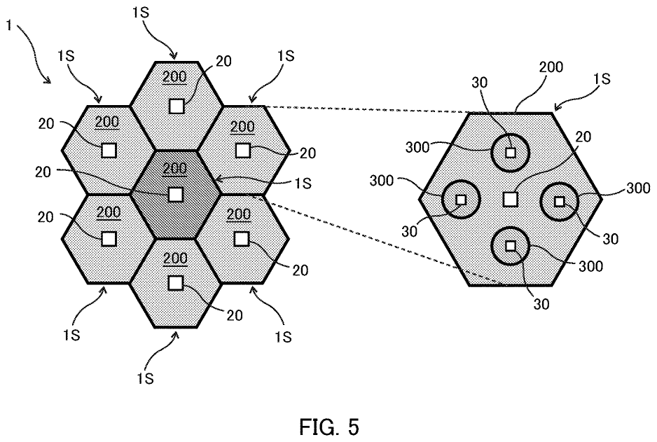

FIG. 5 is an illustration showing an example of the plural-HetNet configuration according to the embodiment. The plural-HetNet configuration is a configuration in which the HetNet (heterogeneous network) configuration is expanded into a cellular manner, and plural HetNets are disposed in a cellular manner. In the example of the plural-HetNet configuration in FIG. 5, seven HetNets 1S are disposed in a cellular manner. Each of the plural HetNets 1S includes the macro cell 200 formed by the macro-cell base station 20 and one or plural small cells 300 formed in the macro cell 200 by one or plural small-cell base stations 30. In the example of FIG. 5, four small cells 300 are included inside the macro cell 200.

In the plural-HetNet configuration exemplified in FIG. 5, an interference occurs between the cells 200 and 300 included in each of the HetNets 1S. The number of interferences increases compared to the case of only the single HetNet or only the cellular configuration.

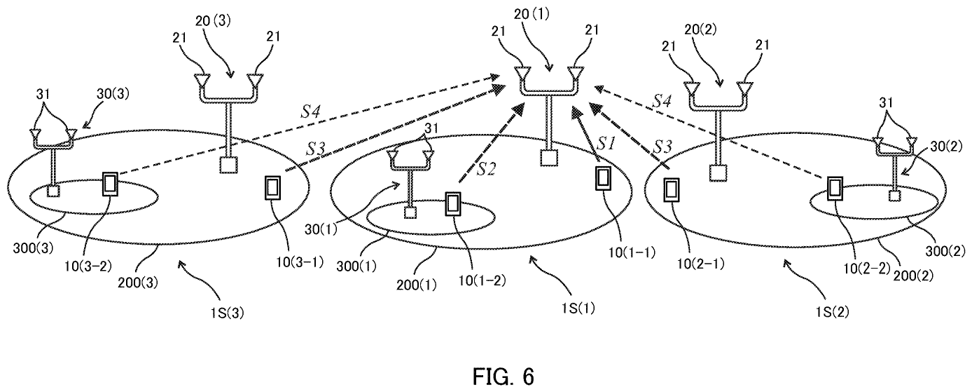

FIG. 6 is an illustration showing an example of a model of signals in the plural-HetNet configuration according to the embodiment. Although, FIG. 6 exemplifies the case that the number of HetNets 1S in the plural-HetNet configuration is three, the number of HetNets 1S may be two, four or more. Furthermore, in each HetNet 1S, although the number of small cells 300 formed in the macro cell 200 is one, the number of small cells 300 may be two or more.

In the signal model of the plural-HetNet configuration of FIG. 6, at an antenna 21 of a base station 20(1) of a target macro cell 200(1) of a central HetNet 1S(1), a desired signal (hope signal) S1 arrives from a macro cell terminal (hereinafter also referred to as a “central-macro cell terminal”) 10(1-1) located in the central macro cell 200(1), and the following three types of interference signals S2, S3 and S4 arrive from surrounding terminals.

The interference signals S2 are interference signals from a small cell terminal (central-small cell terminal) 10(1-2) located in the small cell 300(1) formed inside the target macro cell 200(1). The interference signals S3 are interference signals from macro-cell terminals (hereinafter also referred to as “surrounding macro-cell terminals”) 10(2-1) and 10(3-1) located in the surrounding macro cells 200(2) and 200(3). The interference signals S4 are interference signals from small-cell terminals (hereinafter also referred to as “surrounding small-cell terminals”) 10(2-2) and (3-2) located in the surrounding small cells 300(2) and 300(3) formed inside the surrounding macro cells 200(2) and 200(3).

In the plural-HetNet configuration of FIG. 6, compared to the case of only the single HetNet configuration, the communication quality of the uplink of the central macro-cell base station 20(1) decreases due to an increase in the interference signals S3 from the surrounding macro-cell terminals 10(2-1) and 10(3-1) located in the surrounding macro cells 200(2) and 200(3) and an increase in the interference signals S4 from the surrounding small-cell terminals 10(2-2) and (3-2) located in the surrounding small cells 300(2) and 300(3).

In the interference cancellation system for the plural-HetNet configuration of the present embodiment, in addition to the interference from the central small-cell terminal in the system of FIG. 4 described above, the interferences from the surrounding macro-cell terminals 10(2-1) and 10(3-1), which are surrounding terminals with high transmission power, are suppressed.

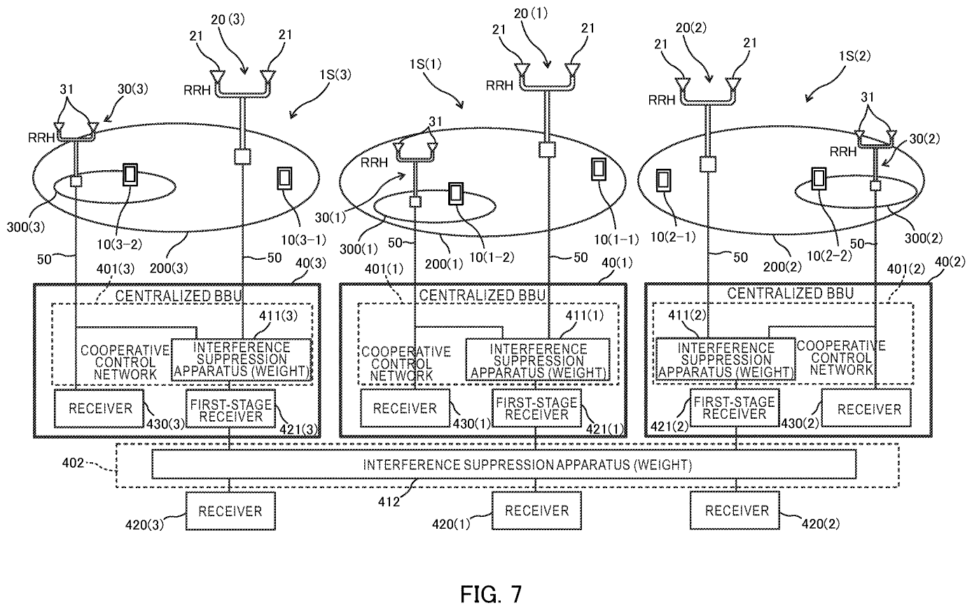

FIG. 7 is a diagram showing a configuration example of a system having a function of a received interference canceller for plural base stations in the plural-HetNet configuration according to the embodiment. It is noted that, in the system of

FIG. 7, the description of parts having the same configuration as the system of FIG. 4 described above is omitted.

The system of FIG. 7 is provided with a two-stage interference canceller for reducing interferences from surrounding macro-cell terminals. The two-stage interference canceller is provided with a plurality of first-stage interference suppression apparatuses (interference cancellers) 411(1) to 411(3) for suppressing the interference signal S2 from the central small-cell terminal in each of the HetNets 1S(1) to 1S(3) of the plural-HetNet configuration, and a second-stage interference suppression apparatus (interference canceller) 412 for suppressing the interference signal S3 from the surrounding macro-cell terminals in the plural-HetNet configuration.

The interference canceller for the single HetNet configuration in FIG. 4 described above can be applied to each of the plurality of the first-stage interference suppression apparatuses (interference cancellers) 411(1) to 411(3). The first-stage interference suppression apparatuses 411(1) to 411(3) are provided in the cooperative control networks 401(1) to 401(3) of the centralized BBUs 40(1) to 40(3) of each of the HetNets 1S(1) to 1S(3), and suppress the interference from the small-cell terminals 10(1-2), 10(2-2) and 10(3-2) to each of the macro-cell base stations 20(1) to 20(3). Each of the cooperative control networks 401(1) to 401(3) is a network in which the macro-cell base stations 20(1) to 20(3) and the small-cell base stations 30(1) to 30(3) communicate with each other and perform a cooperative control. The reception signals, in which interference from the small cell terminals has been suppressed, are received by first-stage receivers 421(1) to 421(3) provided in the centralized BBUs 40(1) to 40(3).

The second-stage interference suppression apparatus (interference canceller) 412 can apply the interference canceller for suppressing the uplink interference signals from the surrounding macro-cell terminals with respect to the uplink signals of the macro-cell base station after application of the interference canceller for the single HetNet configuration in FIG. 4 described above. The second-stage interference suppression apparatus 412 is provided in the cooperative control network 402 between the HetNets, and suppresses the interference signals from the surrounding macro-cell terminals 10(2-1) and 10(3-1) using the reception signals of each of the macro-cell base stations 20(1) to 20(3) after the first-stage interference cancellation. The cooperative control network 402 is a network in which the centralized BBUs 40(1) to 40(3) of the macro-cell base stations 20(1) to 20(3) of the plural HetNets communicate with each other and perform a cooperative control.

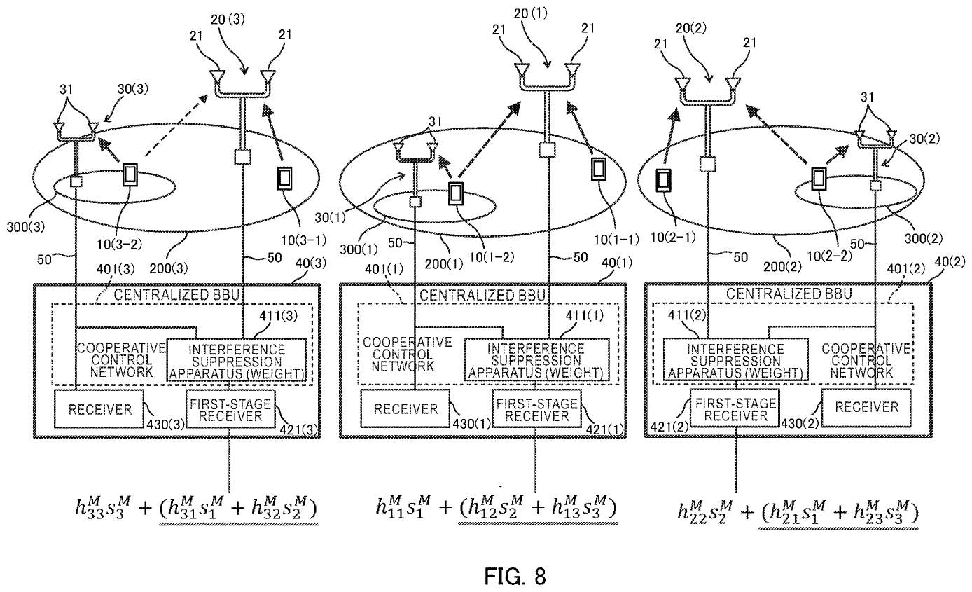

FIG. 8 is a diagram showing an example of the first-stage interference suppression apparatus (received interference canceller) in the system of FIG. 7. In each of the plural first-stage interference suppression apparatuses 411(1) to 411(3), the same process as that of the interference suppression apparatus 410 in the case of the above-mentioned single HetNet configuration is performed, and the interference from the small cell terminals 10(1-2) to 10(3-2) in the macro cells 200(1) to 200(3) is suppressed. Each of the first-stage receivers 421(1) to 421(3) outputs intermediate signals S1′, S2′, and S3′ in which the interference from the small-cell terminals 10(1-2) to 10(3-2) is suppressed. For example, the first-stage receiver 421(1) in the center of FIG. 8 outputs an intermediate signal S1′ (=h₃₃^{M}s₃^{M}+(h₃₁^{M}s₁^{M}+h₃₂^{M}s₂^{M})). The first-stage receiver 421(2) on the right side of FIG. 8 outputs an intermediate signal S2′ (=h₂₂^{M}s₂^{M}+ (h₂₁^{M}s₁^{M}+h₂₃^{M}s₃^{M})). The first-stage receiver 421(3) on the left side of FIG. 8 outputs an intermediate signal S3′ (=h₃₃^{M}s₃^{M}+(h₃₁^{M}s₁^{M}+h₃₂^{M}s₂^{M})). Signal components enclosed in brackets of the intermediate signals S1′, S2′, and S3′ are remaining interference signals from the surrounding macro cells.

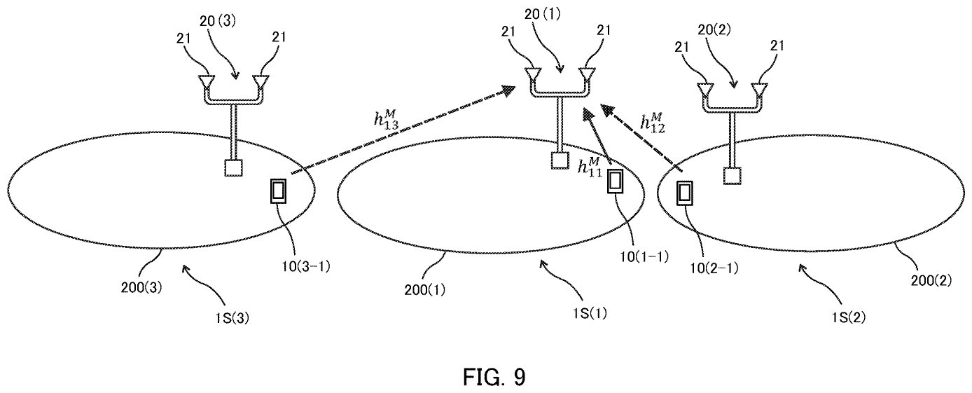

FIG. 9 is a diagram showing an example of an application effect of the first-stage interference suppression apparatus (received interference canceller). By applying the first-stage interference suppression apparatuses (received interference cancellers) 411(1) to 411(3), the interference from the small-cell terminals 10(1-2) to 10(3-2) is suppressed in each of the macro-cell base stations 20(1) to 20(3). Therefore, the plural-HetNet configuration can be regarded as a cell configuration in which there are no small cells 300(1) to 300(3) and are only macro cells 200(1) to 200(3). It can be considered that only interference signals from the macro-cell terminals located in the surrounding macro cells arrive at each of the macro-cell base stations 20(1) to 20(3). For example, as exemplified in FIG. 9, it can be considered that a desired signal h₁₁^{M} from the macro cell terminal 10(1-1) located in the own cell 200(1) arrives at the antenna 21 of the central-macro cell base station 20(1), and the interference signals h₁₂^{M} and h₁₃^{M} from the macro cell terminals 10(2-1) and 10(3-1) located in the surrounding macro cells 200(2) and 200(3) arrive at the antenna 21 of the central-macro cell base station 20(1).

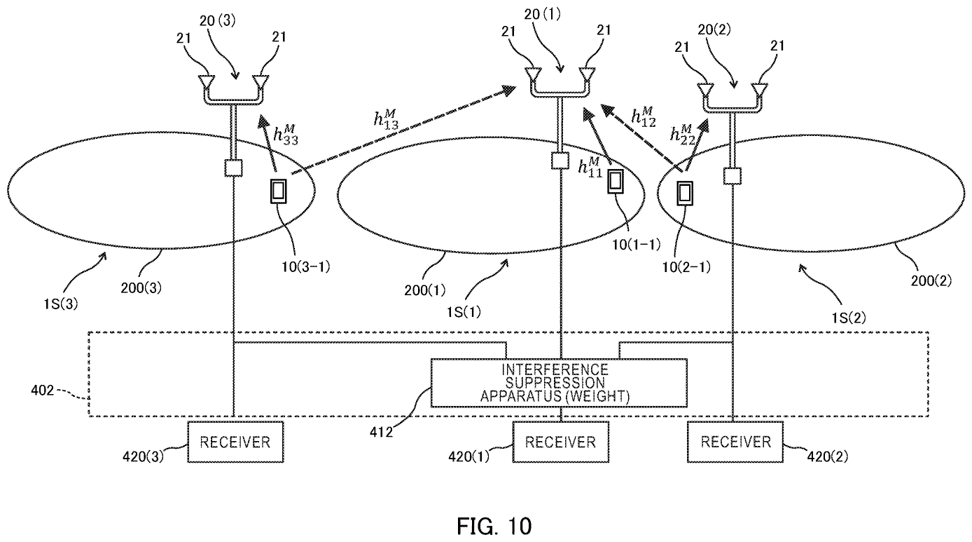

FIG. 10 is a diagram showing an example of the second-stage interference suppression apparatus (received interference canceller) in the system of FIG. 7. As exemplified in FIG. 10, in the second-stage interference suppression apparatus (received interference canceller) 412, the signal of the macro-cell base station after the first-stage interference cancellation is used to suppress the interference from the surrounding macro-cell base stations 20(2) and 20(3) at the central-macro cell base station 20(1).

The interference cancellation weights used in the second-stage interference suppression apparatus (received interference canceller) 412 can be obtained, for example, by the following steps (1) to (4).

(1) Each of the macro-cell base stations 20(1) to 20(3) measures the propagation path responses from the surrounding macro cells. For example, if the number of surrounding macro cells is N_{M}, then each macro-cell base station needs to measure the propagation path responses of N_{M}.

(2) The interference suppression apparatus 412 collects the propagation path responses hⱼᵢ^{M} between the surrounding macro cells to create a propagation path response matrix H_{M}. For example, if the number of surrounding macro cells N_{M} is four (N_{M}=4), then the propagation-path response matrix H_{M} of the following equation (6) is generated.

$${H}^{M} = [ \begin{matrix}{h}_{22}^{M} & {h}_{32}^{M} & {h}_{42}^{M} & {h}_{52}^{M} \\ {h}_{23}^{M} & {h}_{33}^{M} & {h}_{43}^{M} & {h}_{53}^{M} \\ {h}_{24}^{M} & {h}_{34}^{M} & {h}_{44}^{M} & {h}_{54}^{M} \\ {h}_{25}^{M} & {h}_{35}^{M} & {h}_{45}^{M} & {h}_{55}^{M}\end{matrix} ] \qquad ( 6 )$$

(3) Furthermore, the interference suppression apparatus 412 collects the propagation path responses h₁ᵢ^{M} from the surrounding macro cells to the central macro cell to generate a propagation-path response matrix h₀^{M}. For example, if the number of surrounding macro cells N_{M} is four (N_{M}=4), then the propagation-path response matrix h₀^{M} of the following equation (7) is generated.

$${h}_{0}^{M} = [ \begin{matrix}{h}_{12}^{M} \\ {h}_{13}^{M} \\ {h}_{14}^{M} \\ {h}_{15}^{M}\end{matrix} ] \qquad ( 7 )$$

The interference suppression apparatus 412 determines the interference cancellation weight (reception weight) W^{MC} by the following equation (8), using the propagation-path response matrix H_{M} between the surrounding macro cells and the propagation-path response matrix h₀^{M} from the surrounding macro cells to the central macro cell. For example, if the number of surrounding macro cells N_{M} is four (N_{M}=4), then the interference cancellation weight W^{MC} of the following equation (9) is determined.

$${W}^{{M}^{C}} = - {H}^{M - 1} {h}_{0}^{M} \qquad ( 8 )$$

$$[ \begin{matrix}{W}_{1}^{{M}^{C}} \\ {W}_{2}^{{M}^{C}} \\ {W}_{3}^{{M}^{C}} \\ {W}_{4}^{{M}^{C}}\end{matrix} ] = {[ \begin{matrix}{h}_{22}^{M} & {h}_{32}^{M} & {h}_{42}^{M} & {h}_{52}^{M} \\ {h}_{23}^{M} & {h}_{33}^{M} & {h}_{43}^{M} & {h}_{53}^{M} \\ {h}_{24}^{M} & {h}_{34}^{M} & {h}_{44}^{M} & {h}_{54}^{M} \\ {h}_{25}^{M} & {h}_{35}^{M} & {h}_{45}^{M} & {h}_{55}^{M}\end{matrix} ]}^{- 1} [ \begin{matrix}{h}_{12}^{M} \\ {h}_{13}^{M} \\ {h}_{14}^{M} \\ {h}_{15}^{M}\end{matrix} ] \qquad ( 9 )$$

A reception signal S0 after the interference cancellation in which the interference is suppressed using the interference cancellation weight W^{MC} can be expressed by the following equation (10). Herein, in the equation (10), x₀^{M} represents the reception signal transferred from the central macro-cell base station 20(1) to the interference suppression apparatus 412, X represents the matrix of the reference signals transferred from the surrounding-macro base stations to the interference suppression apparatus 412, and T represents the transpose.

$${x}_{0}^{M} + {( {W}^{{M}^{C}} )}^{T} {X}^{M} = {s}_{0} \qquad ( 10 )$$

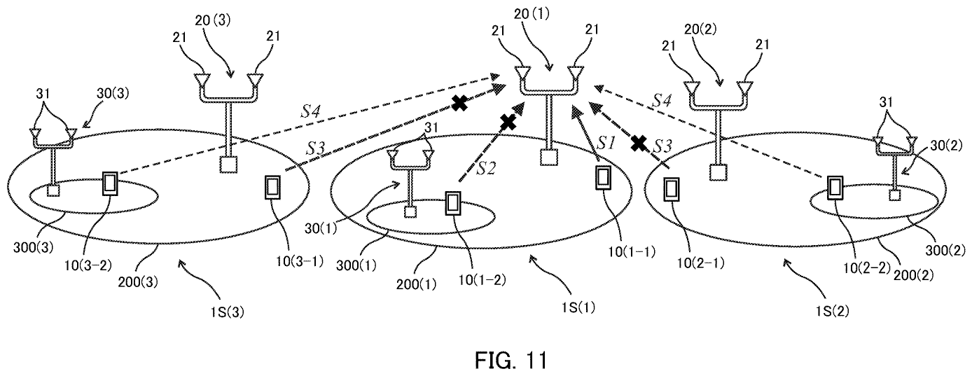

FIG. 11 is a diagram showing an example of an application effect of the first-stage interference suppression apparatus (received interference canceller) and the second-stage interference suppression apparatus (received interference canceller) in the plural-HetNet configuration of the system according to the embodiment. As shown in FIG. 11, by applying the interference cancellation system provided in the plural first-stage interference suppression apparatuses 411(1) to 411(3) and the second-stage interference suppression apparatus 412 of the present embodiment, it is possible to suppress the interference signals S2 from the small-cell terminals in the own cell of each macro-cell base station and the interference signals S3 from the surrounding macro-cell terminals, and to significantly improve the reception SINR of the macro-cell base station.

Next, a description is given of a reduction of signal processing amount in the second-stage interference suppression apparatus (received interference canceller) 412 in the system of the present embodiment.

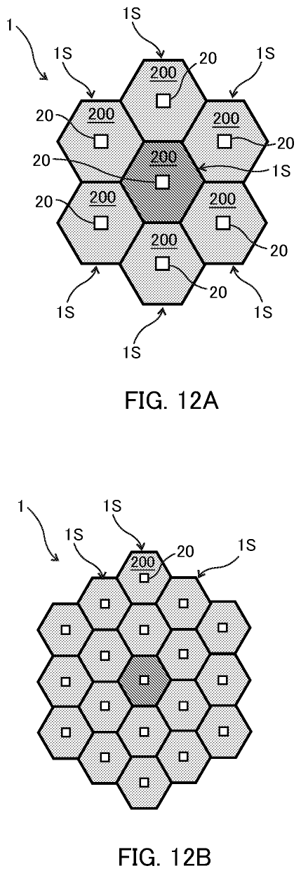

As the number of the surrounding macro cells increases, the signal processing amount in the second-stage interference suppression apparatus 412 increases. For example, when the number of the surrounding macro cells N_{M} is six in the plural-HetNet configuration as shown in FIG. 12A, the interference cancellation weight (reception weight) W^{MC} is determined by the following equation (11). In this case, a signal processing including a calculation of a 6×6 inverse matrix is performed.

$$[ \begin{matrix}{W}_{1}^{{M}^{C}} \\ {W}_{2}^{{M}^{C}} \\ {W}_{3}^{{M}^{C}} \\ {W}_{4}^{{M}^{C}} \\ {W}_{5}^{{M}^{C}} \\ {W}_{6}^{{M}^{C}}\end{matrix} ] = {[ \begin{matrix}{h}_{22}^{M} & {h}_{32}^{M} & {h}_{42}^{M} & {h}_{52}^{M} & {h}_{62}^{M} & {h}_{72}^{M} \\ {h}_{23}^{M} & {h}_{33}^{M} & {h}_{43}^{M} & {h}_{53}^{M} & {h}_{63}^{M} & {h}_{73}^{M} \\ {h}_{24}^{M} & {h}_{34}^{M} & {h}_{44}^{M} & {h}_{54}^{M} & {h}_{64}^{M} & {h}_{74}^{M} \\ {h}_{25}^{M} & {h}_{35}^{M} & {h}_{45}^{M} & {h}_{55}^{M} & {h}_{65}^{M} & {h}_{75}^{M} \\ {h}_{26}^{M} & {h}_{36}^{M} & {h}_{47}^{M} & {h}_{56}^{M} & {h}_{66}^{M} & {h}_{76}^{M} \\ {h}_{27}^{M} & {h}_{37}^{M} & {h}_{47}^{M} & {h}_{57}^{M} & {h}_{67}^{M} & {h}_{77}^{M}\end{matrix} ]}^{- 1} [ \begin{matrix}{h}_{12}^{M} \\ {h}_{13}^{M} \\ {h}_{14}^{M} \\ {h}_{15}^{M} \\ {h}_{16}^{M} \\ {h}_{17}^{M}\end{matrix} ] \qquad ( 11 )$$

When the number of the surrounding macro cells is an arbitrary N_{M} in the plural-HetNet configuration as shown in FIG. 12B, the interference cancellation weight (reception weight) W^{MC} is determined by the following equation (12). In this case, a signal processing including a calculation of an N_{M}×N_{M} inverse matrix is performed. As the number of the surrounding macro cells N_{M} increases, the signal processing amount including the calculation of the N_{M}×N_{M} inverse matrix increases when the interference cancellation weight (reception weight) W^{MC} is determined in the second-stage interference suppression apparatus 412. That is, in order to generate the weight matrix W^{MC} of the interference cancellation weights (reception weights), it is necessary to solve the inverse matrix H⁻¹ of the N_{M}×N_{M} propagation-path response matrix H, and as the number of the surrounding macro cells N_{M} increases, the calculation processing time for the inverse matrix H⁻¹ increases.

$$[ \begin{matrix}{W}_{1}^{{M}^{C}} \\ {W}_{2}^{{M}^{C}} \\ ⋮ \\ {W}_{{N}_{M}}^{{M}^{C}}\end{matrix} ] = {[ \begin{matrix}{h}_{22}^{M} & {h}_{32}^{M} & … & {h}_{{N}_{M} + 12}^{M} \\ {h}_{23}^{M} & {h}_{33}^{M} & … & {h}_{{N}_{M} + 13}^{M} \\ ⋮ & ⋮ & ⋱ & ⋮ \\ {h}_{2 {N}_{M} + 1}^{M} & {h}_{3 {N}_{M} + 1}^{M} & … & {h}_{{N}_{M} + 1 {N}_{M} + 1}^{M}\end{matrix} ]}^{- 1} [ \begin{matrix}{h}_{12}^{M} \\ {h}_{13}^{M} \\ ⋮ \\ {h}_{1 {N}_{M} + 1}^{M}\end{matrix} ] \qquad ( 12 )$$

In the system of the present embodiment, as shown below, the signal processing amount is reduced by reducing the number of propagation paths when determining the interference cancellation weight (reception weight) W^{MC}.

In the present embodiment, attention is paid to the fact that an electric power may not reach depending on the distance between the macro-cells and the propagation path conditions, and as shown in the following equation (13), propagation paths where the electric power does not reach are excluded from the process for determining the interference cancellation weight (reception weight) W^{MC} in the second-stage interference suppression apparatus (received interference canceller).

$$[ \begin{matrix}{W}_{1}^{{M}^{C}} \\ {W}_{2}^{{M}^{C}} \\ {W}_{3}^{{M}^{C}} \\ {W}_{4}^{{M}^{C}} \\ {W}_{5}^{{M}^{C}} \\ {W}_{6}^{{M}^{C}}\end{matrix} ] = {[ \begin{matrix}{h}_{22}^{M} & {h}_{32}^{M} & 0 & 0 & 0 & 0 \\ {h}_{23}^{M} & {h}_{33}^{M} & {h}_{43}^{M} & 0 & 0 & 0 \\ 0 & {h}_{34}^{M} & {h}_{44}^{M} & {h}_{54}^{M} & 0 & 0 \\ 0 & 0 & {h}_{45}^{M} & {h}_{55}^{M} & {h}_{65}^{M} & 0 \\ 0 & 0 & 0 & {h}_{56}^{M} & {h}_{66}^{M} & {h}_{76}^{M} \\ 0 & 0 & 0 & 0 & {h}_{67}^{M} & {h}_{77}^{M}\end{matrix} ]}^{- 1} [ \begin{matrix}{h}_{12}^{M} \\ {h}_{13}^{M} \\ {h}_{14}^{M} \\ {h}_{15}^{M} \\ {h}_{16}^{M} \\ {h}_{17}^{M}\end{matrix} ] \qquad ( 13 )$$

As a determination method for determining a propagation path to be reduced from the process for determining the interference cancellation weight (reception weight) W^{MC}, for example, there are the following determination methods 1 to 3.
Determination method 1: Instantaneous setting of propagation path response.
Determination method 2: Presetting of propagation path response.
Determination method 3: Instantaneous setting of propagation path response+Presetting of propagation path response.

### [Signal Processing Amount Reduction Method 1]

In the first method of signal processing amount reduction, the foregoing determination method 1 (instantaneous setting of propagation path response) is used, the propagation path response is measured at regular time intervals, and the propagation path response is set according to the magnitude of the electric power.

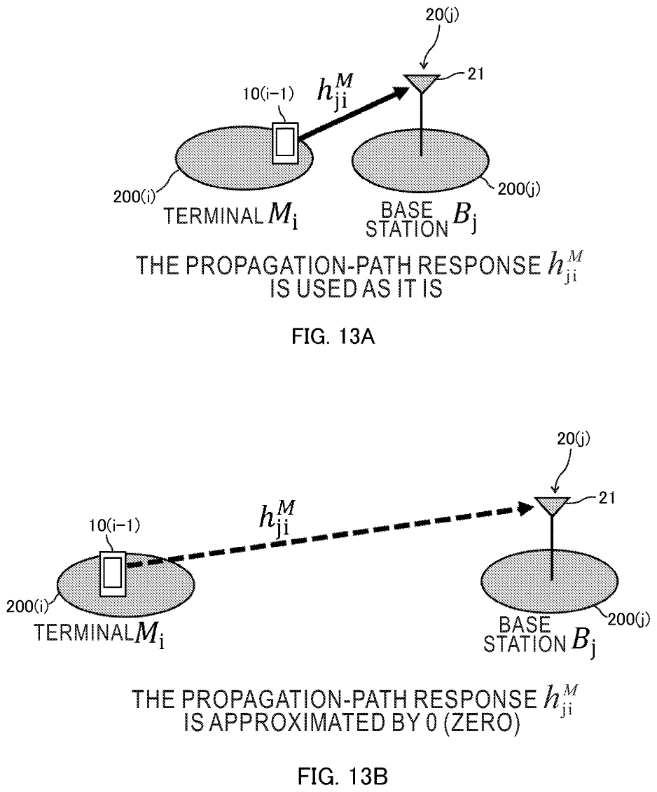

For example, in a situation where the interference between the macro cells is large, such as when the distance between the macro cells 200(i) and 200(j) is short as shown in FIG. 13A, since it is necessary to cancel the interference, for the propagation path response hⱼᵢ corresponding to the path between the macro cells in the propagation-path response matrix used to calculate the interference cancellation weight, the estimated (measured) value is used as it is.

On the other hand, in a situation where the interference between the macro cells is small, such as when the distance between macro-cells 200(i) and 200(j) is far as shown in FIG. 13B, since there is no need to cancel the interference, the propagation path response hⱼᵢ corresponding to the path between the macro-cells in the propagation-path response matrix used to calculate the interference cancellation weight is approximated to 0 (zero).

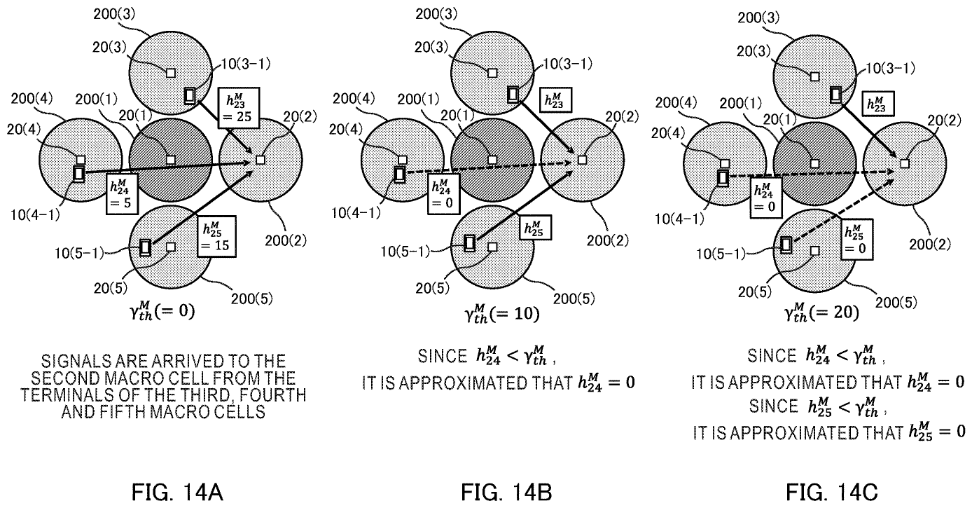

FIGS. 14A to 14C are diagrams showing specific examples of approximations of propagation path responses hⱼᵢ^{M} when first threshold values γₜₕ^{M} different from each other are set in the first-signal processing amount reduction method. Although FIGS. 14A to 14C respectively show an example in which the number of the surrounding macro cells is four, the number of surrounding macro cells may be two, three, or five or more.

In the specific example of the first-signal processing amount reduction method, a predetermined first threshold value γₜₕ^{M} for reception power is set, and a relevant propagation path response hⱼᵢ^{M} is measured. When the electric power of the propagation path response hⱼᵢ^{M} is smaller than the first threshold value γₜₕ^{M}, or equal to or less than the first threshold value γₜₕ^{M}, the relevant propagation pass response hⱼᵢ^{M} is approximated to zero (hⱼᵢ^{M}=0).

In the example of FIG. 14A, the first threshold value γₜₕ^{M}=0 [dB] is set, and it is determined that signals arrive at the antenna of the second-macro cell base station 20(2) from the terminals 10(3-1), 10(4-1), and 10(5-1) located in the third, fourth and fifth macro-cells 200(3), 200(4), and 200(5) and the signals cause interference. Therefore, the propagation path responses h₂₃^{M}, h₂₄^{M} and h₂₅^{M} are not approximated to 0 (zero).

In the example of FIG. 14B, the first threshold value γₜₕ^{M}=10 [dB] is set, and it is determined that no signal arrives at the antenna of the second-macro cell base station 20(2) from the terminal 10(4-1) located in the fourth macro cell 200(4). That is, since it is determined that |h₂₄^{M}|²<γₜₕ, the propagation path response h₂₄^{M} is approximated to zero (h₂₄^{M}=0). On the other hand, signals arrive at the antenna of the second-macro cell base station 20(2) from the terminals 10(3-1) and 10(5-1) located in the third and fifth macro-cells 200(3) and 200(5) and the signals cause interference, so the propagation path responses h₂₃^{M} and h₂₅^{M} are not approximated to 0 (zero).

In the example of FIG. 14C, the first threshold value γₜₕ^{M}=20 [dB] is set, and it is determined that no signal arrives at the antenna of the second-macro cell base station 20(2) from the terminals 10(4-1) and 10(5-1) located in the fourth and fifth macro cells 200(4) and 200(5). That is, since it is determined that |h₂₄^{M}|²<γₜₕ and |h₂₅^{M}|²<γₜₕ, the propagation path responses h₂₄^{M} and h₂₅^{M} are approximated to zero (h₂₄^{M}=0 and h₂₅^{M}=0). On the other hand, a signal arrives at the antenna of the second-macro cell base station 20(2) from the terminal 10(3-1) located in the third macro cell 200(3) and the signal causes interference, so the propagation path response h₂₃^{M} is not approximated to 0 (zero).

When the first-signal processing amount reduction method is not applied in the plural-HetNet configuration in which the number of the surrounding macro cells is four as shown in FIGS. 14A to 14C, the calculation formula for the interference cancellation weight W^{MC} including the inverse matrix of the propagation-path response matrix H^{M} of the propagation path response hⱼᵢ between the macro cells, which calculates the inverse matrix shown in the following equation (14), is, for example, as shown in the following equation (15).

$${W}^{{M}^{C}} = - {H}^{{M}^{- 1}} {h}_{0}^{M} \qquad ( 14 )$$

$$[ \begin{matrix}{W}_{1}^{{M}^{C}} \\ {W}_{2}^{{M}^{C}} \\ {W}_{3}^{{M}^{C}} \\ {W}_{4}^{{M}^{C}}\end{matrix} ] = {[ \begin{matrix}{h}_{22}^{M} & {h}_{32}^{M} & {h}_{42}^{M} & {h}_{52}^{M} \\ {h}_{23}^{M} & {h}_{33}^{M} & {h}_{43}^{M} & {h}_{53}^{M} \\ {h}_{24}^{M} & {h}_{34}^{M} & {h}_{44}^{M} & {h}_{54}^{M} \\ {h}_{25}^{M} & {h}_{35}^{M} & {h}_{45}^{M} & {h}_{55}^{M}\end{matrix} ]}^{- 1} [ \begin{matrix}{h}_{12}^{M} \\ {h}_{13}^{M} \\ {h}_{14}^{M} \\ {h}_{15}^{M}\end{matrix} ] \qquad ( 15 )$$

On the other hand, when the first-signal processing amount reduction method is applied in the plural-HetNet configuration in which the number of the surrounding macro cells is four, the calculation formula for the interference cancellation weight W^{MC} is, for example, a sparse matrix as shown in the following equation (16).

$$[ \begin{matrix}{W}_{1}^{{M}^{C}} \\ {W}_{2}^{{M}^{C}} \\ {W}_{3}^{{M}^{C}} \\ {W}_{4}^{{M}^{C}}\end{matrix} ] = - {[ \begin{matrix}{h}_{22}^{M} & & & {h}_{52}^{M} \\ {h}_{23}^{M} & {h}_{33}^{M} & & \\ & {h}_{34}^{M} & {h}_{44}^{M} & \\ & & {h}_{45}^{M} & {h}_{55}^{M}\end{matrix} ]}^{- 1} [ \begin{matrix}{h}_{12}^{M} \\ {h}_{13}^{M} \\ {h}_{14}^{M} \\ {h}_{15}^{M}\end{matrix} ] = - {[ \begin{matrix}{h}_{22}^{M} & 0 & 0 & {h}_{52}^{M} \\ {h}_{23}^{M} & {h}_{33}^{M} & 0 & 0 \\ 0 & {h}_{34}^{M} & {h}_{44}^{M} & 0 \\ 0 & 0 & {h}_{45}^{M} & {h}_{55}^{M}\end{matrix} ]}^{- 1} [ \begin{matrix}{h}_{12}^{M} \\ {h}_{13}^{M} \\ {h}_{14}^{M} \\ {h}_{15}^{M}\end{matrix} ] \qquad ( 16 )$$

In the sparse matrix (matrix with many zero elements) such as the propagation-path response matrix H^{M} in the equation (16), the amount of calculation required to find the inverse matrix can be reduced compared to the original matrix (full matrix) shown in the following equation (17). The more the number of the elements with zero is, the more the amount of calculation required to find the inverse matrix can be reduced. In this way, by approximating many of the elements in the propagation-path response matrix H^{M} to zero (0), the amount of calculation required to generate the interference cancellation weights can be reduced.

$${H}^{M} = [ \begin{matrix}{h}_{22}^{M} & {h}_{32}^{M} & {h}_{42}^{M} & {h}_{52}^{M} \\ {h}_{23}^{M} & {h}_{33}^{M} & {h}_{43}^{M} & {h}_{53}^{M} \\ {h}_{24}^{M} & {h}_{34}^{M} & {h}_{44}^{M} & {h}_{54}^{M} \\ {h}_{25}^{M} & {h}_{35}^{M} & {h}_{45}^{M} & {h}_{55}^{M}\end{matrix} ] \qquad ( 17 )$$

When the first threshold value γₜₕ^{M} is small, as shown in the propagation-path response matrix H of the following equation (18), there are few propagation path responses that satisfy |hⱼᵢ|²<γₜₕ and few propagation path responses that can be approximated as hⱼᵢ^{M}=0.

$${H}^{M} = [ \begin{matrix}{h}_{22}^{M} & 0 & {h}_{42}^{M} & {h}_{52}^{M} \\ {h}_{23}^{M} & {h}_{33}^{M} & 0 & {h}_{53}^{M} \\ {h}_{24}^{M} & {h}_{34}^{M} & {h}_{44}^{M} & 0 \\ 0 & {h}_{35}^{M} & {h}_{45}^{M} & {h}_{55}^{M}\end{matrix} ] \qquad ( 18 )$$

As the first threshold value γₜₕ^{M} is increased, as shown in the propagation-path response matrix H^{M} of the following equation (19), the propagation path responses that satisfy |hⱼᵢ^{M}|2<γₜₕ increase, the propagation path responses hⱼᵢ^{M} capable of being approximated to zero (hⱼᵢ^{M}=0) increase, and the propagation-path response matrix H^{M} becomes a sparse matrix.

$${H}^{M} = [ \begin{matrix}{h}_{22}^{M} & 0 & 0 & {h}_{52}^{M} \\ {h}_{23}^{M} & {h}_{33}^{M} & 0 & 0 \\ 0 & {h}_{34}^{M} & {h}_{44}^{M} & 0 \\ 0 & 0 & {h}_{45}^{M} & {h}_{55}^{M}\end{matrix} ] \qquad ( 19 )$$

If the first threshold value γₜₕ^{M} is further increased, as shown in the propagation-path response matrix H^{M} of the following equation (20), the propagation path responses that satisfy |hⱼᵢ^{M}|²<γₜₕ^{M} increase, the propagation path responses hⱼᵢ^{M} capable of being approximated (hⱼᵢ^{M}=0) increase, and the propagation-path response matrix H^{M} becomes a diagonal matrix, which is a sparse matrix with even more zero elements. When the propagation-path response matrix H^{M} is the diagonal matrix, the calculation amount of the inverse matrix of the propagation-path response matrix H^{M} can be significantly reduced as shown in the following equation (21).

$${H}^{M} = [ \begin{matrix}{h}_{22} & 0 & 0 & 0 \\ 0 & {h}_{33}^{M} & 0 & 0 \\ 0 & 0 & {h}_{44}^{M} & 0 \\ 0 & 0 & 0 & {h}_{55}^{M}\end{matrix} ] \qquad ( 20 )$$

$${H}^{- 1} = [ \begin{matrix}1 / {h}_{22}^{M} & 0 & 0 & 0 \\ 0 & 1 / {h}_{33}^{M} & 0 & 0 \\ 0 & 0 & 1 / {h}_{44}^{M} & 0 \\ 0 & 0 & 0 & 1 / {h}_{55}^{M}\end{matrix} ] \qquad ( 21 )$$

### [Signal Processing Amount Reduction Method 2]

In the second method of signal-processing amount reduction method, attention is paid to the fact that the signal transmitted from the terminal located in the surrounding macro cell may not reach the base station antenna of the target macro cell with sufficient power depending on the distance between macro cells 200 and propagation path conditions, and a combination of macro cells for estimating (measuring) the propagation path response is determined in advance so that an estimation (measurement) of the propagation path response is not performed for the propagation path where the signal from the terminal 10 does not arrive with sufficient power.

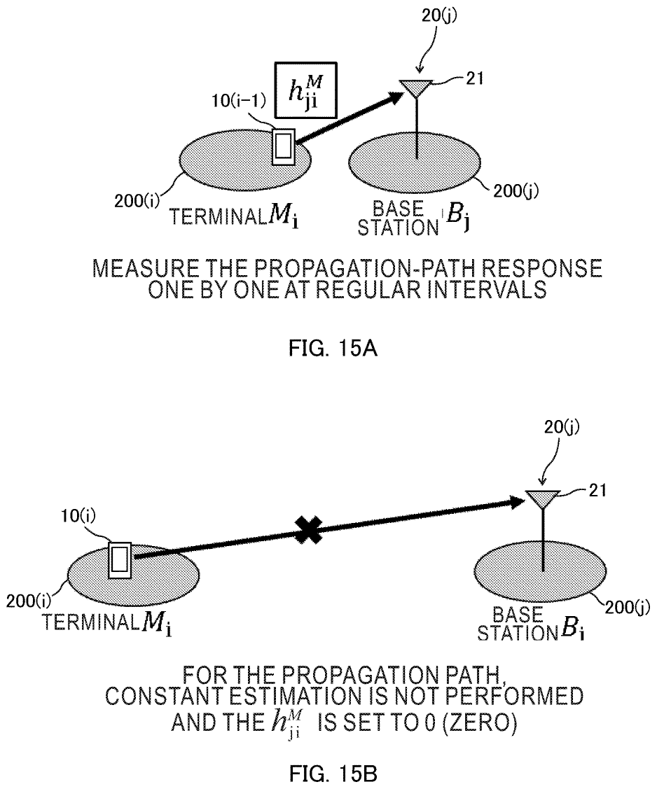

For example, in a path between the macro cells where the signal arrives from the macro-cell terminal with a predetermined power, such as the case that the distance between macro cells 200(i) and 200(j) is short as shown in FIG. 15A, since the propagation path between the macro cells cannot be ignored, so the propagation path response hⱼᵢ^{M} is estimated (measured) one by one.

On the other hand, in the path between the macro cells where the signal from the macro cell terminal has difficulty reaching the macro cells with the predetermined power, such as the case that the distance between macro cells 200(i) and 200(j) is large as shown in FIG. 15B, the propagation path response hⱼᵢ^{M} between the macro cells is not estimated (measured), and the propagation path response hⱼᵢ^{M} is set to 0 (zero) in advance. For example, in a situation where the interference power measured in advance between the macro cells is small, the propagation path response hⱼᵢ^{M} is not constantly estimated, and the propagation path response hⱼᵢ^{M} is set to 0 (zero) in advance.

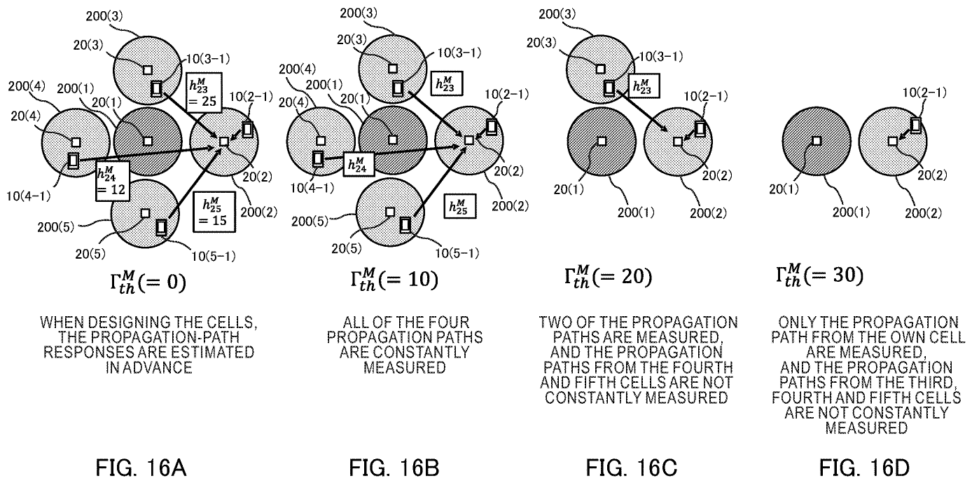

FIGS. 16A to 16D are diagrams showing specific examples of presetting of the propagation path responses hⱼᵢ^{M} when second threshold values Γₜₕ^{M} different from each other are set in the second signal-processing amount reduction method. When designing the cells in FIG. 16A, in a situation where the second threshold value Γₜₕ^{M}=0 [dB] set, the propagation path responses hⱼᵢ^{M} between the macro-cell base station and the macro-cell terminal are estimated in advance based on the reception signal of the macro-cell base station. In the illustrated example, among the four propagation path responses h₂₂^{M}, h₂₃^{M}, h₂₄^{M} and h₂₅^{M} between the macro-cell base station 20(2) and the macro-cell terminals, the propagation path responses h₂₃^{M}, h₂₄^{M} and h₂₅^{M} for the cells other than the own cell are estimated. Based on the comparison results between the calculated values (25 [dB], 12 [dB], 15 [dB]) of electric power of each of the estimated propagation path responses h₂₃^{M}, h₂₄^{M} and h₂₅^{M} and the preset second threshold value Γₜₕ^{M}, it is determined whether or not to perform a continuous measurement of the propagation path response hⱼᵢ^{M} when starting an operation. Although FIGS. 16A to 16D show examples in which the number of the surrounding macro cells is four, the number of the surrounding macro cells may be two, three, five or more.

The example of FIG. 16B is an example in which the second threshold value Γₜₕ^{M} is set to 10 [dB]. In the present example, the electric powers of the propagation path responses h₂₃^{M}, h₂₄^{M} and h₂₅^{M} between the macro-cell base station 20(2) and the macro-cell terminals, which are estimated when designing the cells, are all equal to or greater than the second threshold value Γₜₕ (=0 [dB]). Therefore, after starting the operation, all of the propagation path responses h₂₂^{M}, h₂₃^{M}, h₂₄^{M} and h₂₅^{M} are constantly measured.

The example of FIG. 16C is an example in which the second threshold value Γₜₕ^{M} is set to 20 [dB]. In the present example, among the propagation path responses h₂₃^{M}, h₂₄^{M} and h₂₅^{M} between the macro-cell base station and the macro-cell terminals, which are estimated when designing the cells, the electric power of the propagation path response h₂₃^{M} is equal to or greater than the second threshold value Γₜₕ (=20 [dB]), and the electric powers of the remaining propagation path responses h₂₄^{M} and h₂₅^{M} are less than the second threshold value Γₜₕ (=20 [dB]). Therefore, after starting the operation, the two propagation path responses h₂₂^{M} and h₂₃^{M} are constantly measured, and the remaining propagation path responses h₂₄^{M} and h₂₅^{M} are not constantly measured.

The example of FIG. 16D is an example in which the second threshold value Γₜₕ^{M} is set to 30 [dB]. In the present example, the electric powers of all of the propagation path responses h₂₃^{M}, h₂₄^{M} and h₂₅^{M} between the macro-cell base station and the macro-cell terminals, which are estimated when designing the cells, are less than the second threshold value Γₜₕ (=30 [dB]). Therefore, after starting the operation, only the propagation path response h₂₂^{M} is constantly measured, and the propagation path responses h₂₃^{M}, h₂₄^{M} and h₂₅^{M} are not constantly measured.

In the plural-HetNet configuration in which the number of the surrounding macro cells is four, when the second signal-processing amount reduction method of FIGS. 16A to 16D is applied, among the propagation path responses h₂₃^{M}, h₂₄^{M} and h₂₅^{M} for the cells other than the own cell estimated when designing the cells, the propagation path response hⱼᵢ^{M}, in which a calculated value of electric power of each of the propagation path responses h₂₃^{M}, h₂₄^{M} and h₂₅^{M} is less than, is always set to zero (0), so that it is not necessary to measure a pilot signal one by one in the corresponding propagation path. Furthermore, as the number of the propagation path responses hⱼᵢ^{M} that are always set to zero (0) increases, the total number of the propagation path responses hⱼᵢ^{M} to be measured (estimated) decreases, and the amount of signal processing for measuring (estimating) the propagation path responses in the entire plural-HetNet configuration decreases.

In the second signal-processing amount reducing method, when the second threshold value Γₜₕ is small, there are few propagation path responses that satisfy |hⱼᵢ^{M}|2<Γₜₕ, and there are few settings of hⱼᵢ^{M}=0. On the other hand, when the second threshold value It is large, there are many propagation path responses that satisfy hⱼᵢ^{M}<Γₜₕ, and there are many settings of hⱼᵢ^{M}=0.

For example, in the plural-HetNet configuration in which the number of the surrounding macro cells is four, when the second threshold value Γₜₕ is small, it is possible to reduce the estimation (measurement) process of the four propagation path responses among the propagation path response with sixteen elements, as shown in the propagation-path response matrix H^{M} of the following equation (22). That is, the estimation (measurement) process of the propagation path response can be reduced by 25%.

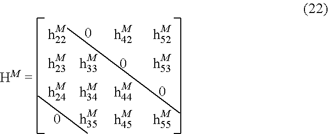

As the second threshold value Γₜₕ is increased, it is possible to reduce the estimation (measurement) process of eight propagation path responses among the propagation path response with sixteen elements, as shown in the propagation-path response matrix H^{M} of the following equation (23). That is, the estimation (measurement) process of the propagation path response can be reduced by 50%.

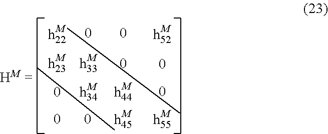

As the second threshold value Γₜₕ is further increased, it is possible to reduce the estimation (measurement) process of twelve propagation path responses among the propagation path response with sixteen elements, as shown in the propagation-path response matrix H^{M} of the following equation (24). That is, the estimation (measurement) process of the propagation path response can be reduced by 75%.

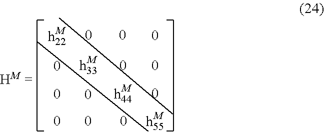

It is noted that, in the example of the signal-processing amount reduction method 2, the propagation path response hⱼᵢ^{M} between the macro-cell base station and the macro cell terminals, which is estimated before starting the operation of the macro-cell base station when designing the cells, is set to zero when the calculated value of the electric power of the propagation path response hⱼᵢ^{M} is equal to or less than the second threshold value Γₜₕ^{M}, or less than the second threshold value Γₜₕ^{M}. However, the propagation path response hⱼᵢ^{M} to be set to zero in advance may be determined based on the positional relationship between the macro-cell base stations 20 or the positional relationship between the macro-cells 200 in the plural-HetNet configuration.

### [Combination of Signal Processing Amount Reduction Methods 1 and 2]

In the system of the present embodiment, the first signal-processing amount reduction method and the second signal-processing amount reduction method may be executed in combination. In this case, a synergistic effect of both methods can be obtained.

First, by using the above-described signal-processing amount reduction method 2, when designing the cells, a combination of macro-cells for estimating (measuring) the propagation path response is determined in advance without estimating the propagation path response of the macro cell with low interference power.

For example, when the number of the surrounding macro cells is four, among the sixteen elements of the propagation-path response matrix H^{M} consisting of the full matrix shown in the following equation (25), for elements in which the electric power of the propagation path response hⱼᵢ^{M} estimated when designing the cells is equal to or less than the second threshold value Γₜₕ, the propagation path response hⱼᵢ^{M} of the corresponding element is set to zero (hⱼᵢ=0) as shown in the following equation (26), and an estimation (measurement) processing of the propagation path response hⱼᵢ^{M} is not performed after starting the operation.

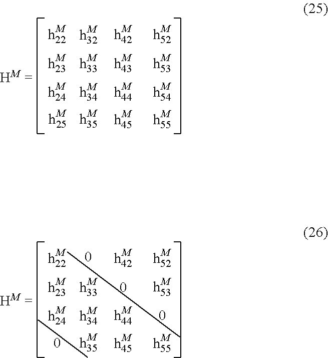

Next, after starting the operation, the reception power P from the macro-cell terminal is measured for the propagation path of the macro cells of the combination determined by the above-mentioned signal-processing amount reduction method 2, and if the reception power P is smaller than a predetermined first threshold value γₜₕ^{M}, the above-mentioned signal-processing amount reduction method 1 is executed to approximate the corresponding propagation path response to zero (0).

For example, at each predetermined time interval Δt after starting the operation, the estimation (measurement) process of the propagation path response hⱼᵢ^{M} is performed for thirteen elements with values other than zero (0) in the propagation-path response matrix of the foregoing equation (26), and for elements in which the electric power of the propagation path response hⱼᵢ^{M} is equal to or less than the first threshold value γₜₕ^{M}, the propagation path response hⱼᵢ^{M} of the corresponding element is approximated to zero (hⱼᵢ^{M}=0) as shown in the following equation (27).

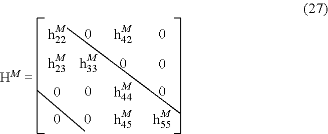

In this way, by combining the first signal-processing amount reduction method and the second signal-processing amount reduction method described above, it is possible to reduce the amount of signal processing for estimating (measuring) the propagation path response and the amount of calculation for generating the interference cancellation weights, compared to when each method is performed alone, and thus to reduce the overall amount of calculation.

### [Appropriate Use of First-Stage Interference Canceller]

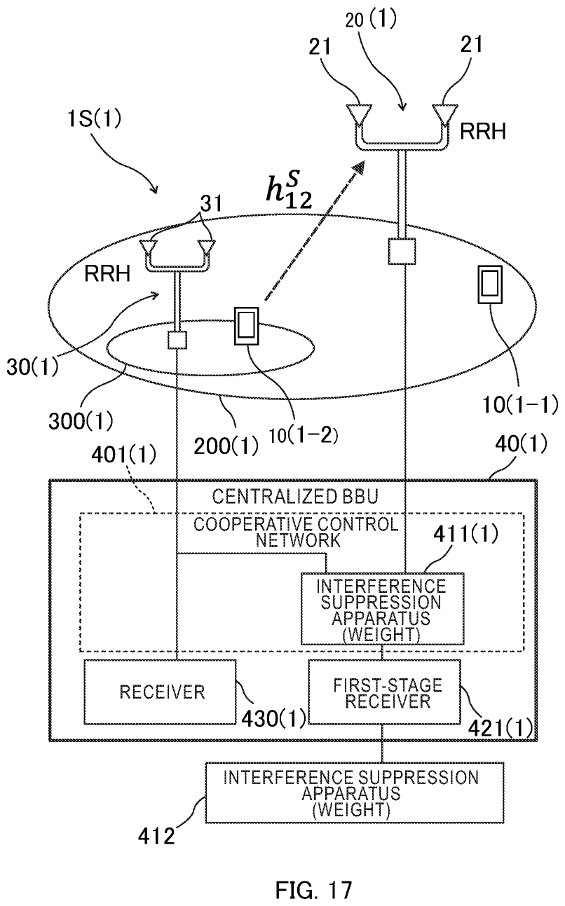

FIG. 17 is a diagram showing an example of a state in which an interference arrives at the macro-cell base station from a terminal of a surrounding small cell in the plural-HetNet configuration. In FIG. 17, when there is no small cell 300 inside the macro cell 200(2) or when the distance between the macro-cell base station 20(1) and the small cell terminal 10(1-2) is long, an interference power may not reach from the small cell terminal 10(1-2) to the macro-cell base station 20. In this case, there is no need to apply the first-stage interference suppression apparatus (interference canceller) 411(1) that suppresses the interference from the small cell terminal 10(1-2) to the macro-cell base station 20(1).

In each of the plural HetNets in the plural-HetNet configuration of the present embodiment, when the electric power of the uplink interference signal from the small-cell terminal located in the small cell 300 relative to the uplink reception signal of the macro-cell base station 20 of the HetNet is equal to or less than a predetermined threshold value, or less than the threshold value, the suppression of the interference signal by the first-stage interference suppression apparatus (interference canceller) 411 described above may not be performed.

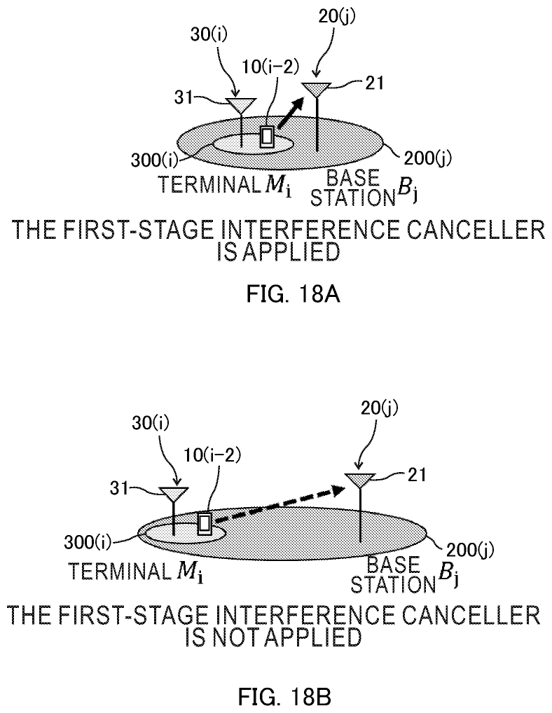

For example, in a situation where there is a lot of interferences between the macro cell and the small cell, such as when the distance between the antenna 21 of the macro-cell base station 20(j) and the small cell terminal 10(i−2) of the small cell 300(i) is short as shown in FIG. 18A, the interference needs to be canceled, so the first-stage interference suppression apparatus (interference canceller) 411 described above is applied to suppress the interference signal.

On the other hand, in a situation where there is a lot of interference between the macro cell and the small cell, such as when the distance between the antenna 21 of the macro-cell base station 20(j) and the small cell terminal 10(i−2) of the small cell 300(i) is large as shown in FIG. 18B, there is no need to cancel the interference, and therefore the first-stage interference suppression apparatus (interference canceller) 411 described above is not applied. In this case, the reception signal of the macro-cell base station 20(j) is used as is in the second-stage interference suppression apparatus (interference canceller).

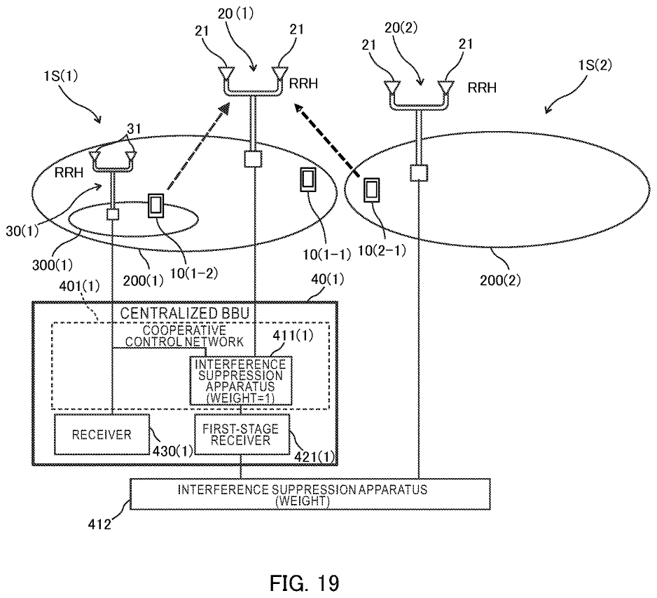

FIG. 19 is a diagram showing an example of processing of the first-stage interference suppression apparatus (received interference canceller) when the interference from the small cell terminal to the antenna of the macro-cell base station is small in the system according to the embodiment. In FIG. 19, the interference power from the small cell terminal 10(1-2) to the macro-cell base station 20(1) is measured in advance. When the interference from the small cell terminal 10(1-2) is smaller than the interference from the surrounding-macro cell terminal 10(2-1) located in the surrounding macro cell 200(2), the weight used in the first-stage interference suppression apparatus 411(1) is set to one (1), the first-stage canceller is not applied, and the reception signal of the macro-cell base station 20 (1) is input as it is to the second-stage interference suppression apparatus 412 and applied to the second-stage canceller.

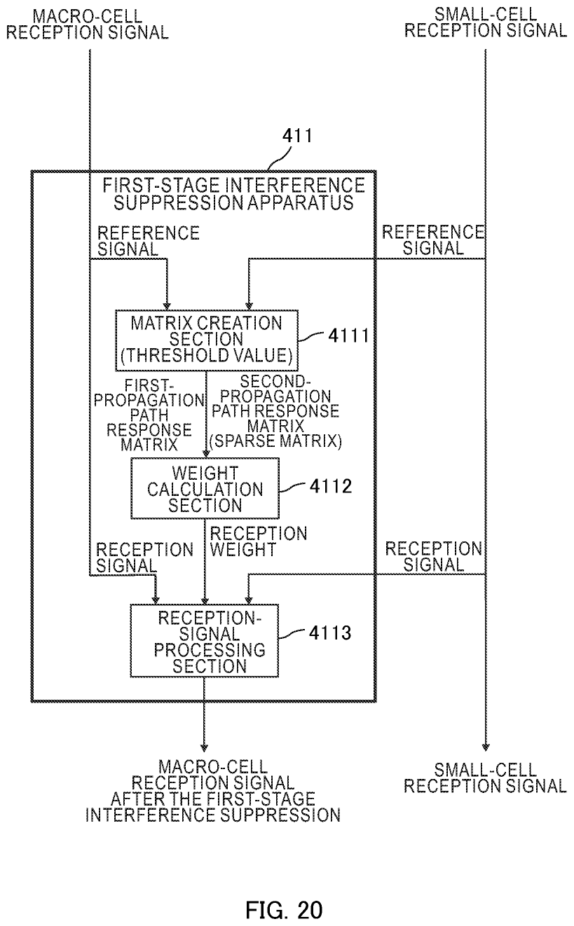

FIG. 20 is a block diagram showing an example of the configuration of the first-stage interference suppression apparatus 411 in the system according to the embodiment. In FIG. 20, the first-stage interference suppression apparatus 411 is an apparatus that suppresses interferences from the terminals located in one or plural small cells 300 to the base station 20 of the target macro cell in each HetNet 1S of the plural-HetNet configuration. The interference suppression apparatus 411 suppresses the interference from the terminal 10(i−2) located in one or plural (N) small cells 300(i) (i=1 to N) to the target macro-cell base station 20, for example, by executing a predetermined program on a computer or processor. The interference suppression apparatus 411 is provided with a matrix creation section 4111, a weight calculation section 4112 and a reception-signal processing section 4113.

The matrix creation section 4111 estimates a first-propagation path response from the terminals located in one or plural small cells 300 to the antenna 21 of the target macro-cell base station 20, creates a first-propagation path response matrix that includes the first-propagation path response as an element, and estimates a second-propagation path response from the terminals located in one or plural small cells 300 to the antenna 31 of one or plural small-cell base stations 30, and creates a second-propagation path response matrix that includes the second-propagation path response as an element.

For example, the matrix creation section 4111 estimates plural first-propagation path responses hi from the plural small cell terminals 10(i−2) to the antenna 21 of the macro-cell base station 20 based on the reception signal (reference signal) of the macro-cell base station 20 that receives pilot signals transmitted from the plural small cell terminals 10(i−2) located in each of the plural small cells 300(i), and creates a first-propagation path response matrix h that includes the plural first-propagation path responses hi as elements.

Furthermore, the matrix creation section 4111 estimates plural second-propagation path responses hji from the plural small cell terminals 10(i−2) to the antenna 31 of the base station 30(j) of the plural small cells 300(j) (j=1 to N), based on reception signals (reference signals) of the plural small-cell base stations 30(i) that receives pilot signals transmitted from the plural small cell terminals 10(i−2), and creates a second-propagation path response matrix H that includes the plural second-propagation path responses hji as elements.

Furthermore, the matrix creation section 4111 sets to zero the second-propagation path responses having electric power of magnitude equal to or less than a predetermined threshold value γth, or less than the threshold value γth, among the plural second-propagation path responses hji included in the second-propagation path response matrix H, before calculating the inverse matrix H⁻¹.

Furthermore, among the plural second-propagation path responses hji of the second-propagation path response matrix H created by the matrix creation section 4111, the second-propagation path response hji, which is expected to have a small contribution to interference with the reception signal of the macro cell uplink, may be set to zero in advance. For example, plural second-propagation path responses hji are estimated before starting the operation of the plural small-cell base stations 30(i), and among the plural second-propagation path responses hji, the second-propagation path responses hji, for which the calculated values of electric power Pji are equal to or less than a predetermined threshold value Γth, or less than the threshold value Γth, are set to zero. Also, for example, the second-propagation path responses hji that are set to zero in advance may be determined based on the positional relationship between plural small-cell base stations 30(i) or the positional relationship between plural small cells 300(i). The matrix creation section 41111 does not estimate the second-propagation path responses hji that are set to zero in advance, among the plural second-propagation path responses hji of the second-propagation path response matrix H.

In addition, in the case that the second-propagation path response hji, which is expected to have a small contribution to interference with the reception signal of the macro cell uplink, is set to zero in advance, the matrix creation section 4111 may further not estimate the second-propagation path response hji that is set to zero in advance among the plural second-propagation path responses hji of the second-propagation path response matrix H, and may correct, to zero, the second-propagation path response in which the calculated value of electric power of the second-propagation path response is equal to or less than the predetermined threshold value γth, or less than the threshold value γth, among the plural second-propagation path responses that are not set to zero in advance.

The weight calculation section 4112 calculates the inverse matrix H⁻¹ of the second-propagation path response matrix H, and calculates one or plural reception weights W to be applied to reception signals received by antennas of one or plural small-cell base stations, based on the inverse matrix H⁻¹ of the second-propagation path response matrix and the first-propagation path response matrix h.

For example, the weight calculation section 4112 calculates the inverse matrix H⁻¹ of the second-propagation path response matrix H, and calculates plural reception weights Wi to be applied to reception signals received by the antennas 31 of the base stations 30(i) of plural small cells, based on the inverse matrix H⁻¹ of the second-propagation path response matrix and the first-propagation path response matrix h.

The reception-signal processing section 4113 suppresses the interference to the uplink of the base station of the target macro cell from one or plural terminals located in the one or plural small cells, based on the reception signal received by the antenna of the base station of the target macro cell, plural reception signals received by antennas of the base stations of one or plural small cells, and the one or plural reception weights.

For example, the reception-signal processing section 4113 suppresses the interference from plural small cell terminals 10(i−2) to the uplink of the target macro-cell base station 20, based on a reception signal X(0) received by the antenna 21 of the target macro-cell base station 20, plural reception signals X(i) received by the antennas 31 of plural small-cell base stations 30(i), and plural reception weights Wi.

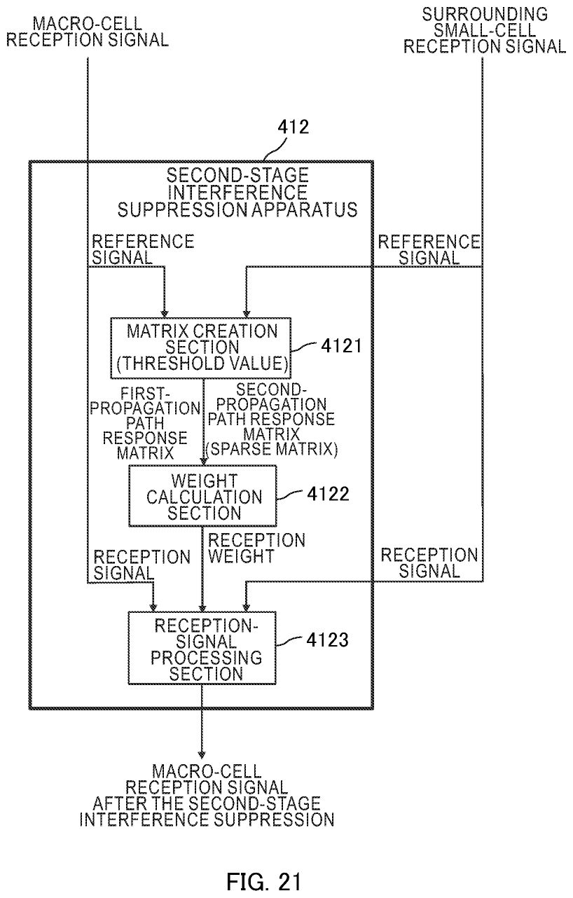

FIG. 21 is a block diagram showing an example of the configuration of the second-stage interference suppression apparatus 412 in the system according to the embodiment. In FIG. 21, the interference suppression apparatus 412 is an apparatus that suppresses interferences from the terminals located in one or plural surrounding macro cells to the base station 20 of the target macro cell in the plural-HetNet configuration. The interference suppression apparatus 412 suppresses the interference from the terminals 10(i−1) located in one or plural (N) surrounding macro cells 200(i) (i=1 to N) to the target macro-cell base station 20, for example, by executing a predetermined program on a computer or processor. The interference suppression apparatus 412 is provided with a matrix creation section 4121, a weight calculation section 4122 and a reception-signal processing section 4123.

The matrix creation section 4121 estimates a third-propagation path response from the macro cell terminal located in each of one or plural surrounding macro cells to the antenna of the base station of the target macro cell, creates a third-propagation path response matrix that includes the third-propagation path response as an element, and estimates a fourth-propagation path response from the macro cell terminals located in one or plural surrounding macro cells to the antennas of the base stations of one or plural surrounding macro cells, and creates a fourth-propagation path response matrix that includes the fourth-propagation path response as an element.

For example, the matrix creation section 4121 estimates plural third-propagation path responses hi from the plural macro cell terminals 10(i−1) to the antenna 21 of the target macro-cell base station 20, based on the reception signal (reference signal) of the target macro-cell base station 20 that receives pilot signals transmitted from the plural macro cell terminals 10(i−1) located in each of the plural surrounding macro cells (other cells) 200(i), and creates a third-propagation path response matrix h that includes the plural third-propagation path responses hi as elements.

Furthermore, the matrix creation section 4121 estimates plural fourth-propagation path responses hⱼᵢ from the plural macro cell terminals 10(i−1) to the antenna 21 of the base station 20(j) of the plural macro cells 200(j) (j=1 to N), based on reception signals (reference signals) of the plural surrounding macro-cell base stations 20(i) that receive pilot signals transmitted from the plural macro cell terminals 10(i−1), and creates a fourth-propagation path response matrix H that includes the plural fourth-propagation path responses hji as elements.

Furthermore, the matrix creation section 4121 sets to zero the fourth-propagation path responses having electric power of magnitude equal to or less than a predetermined threshold value γth, or less than the predetermined threshold value γth, among the fourth-propagation path responses hji included in the fourth-propagation path response matrix H, before calculating the inverse matrix H⁻¹

Furthermore, among the plural fourth-propagation path responses hji of the fourth-propagation path response matrix H created by the matrix creation section 4121, the fourth-propagation path response hji, which is expected to have a small contribution to interference with the reception signal of the macro cell uplink, may be set to zero in advance. For example, the plural fourth-propagation path responses hji are estimated before starting the operation of the plural surrounding macro-cell base stations 20(i), and among the plural fourth-propagation path responses hji, the fourth-propagation path responses hji, for which the calculated values of electric power Pji of the fourth-propagation path responses hji are equal to or less than a predetermined threshold value Γth, or less than the threshold value Γth, are set to zero in advance. Also, for example, the fourth-propagation path response hji to be set to zero in advance may be determined based on the positional relationship between the plural surrounding-macro cell base stations 20(i) or the positional relationship between the plural macro cells 200(i). The matrix creation section 4121 does not estimate the fourth-propagation path response hji that is set to zero in advance among the plural fourth-propagation path responses hji of the fourth-propagation path response matrix H.

In addition, when the fourth-propagation path response hji that is expected to have a small contribution to interference with the reception signal of the macro cell uplink is set to zero in advance, the matrix creation section 4121 may further not estimate the fourth-propagation path response hji that is set to zero in advance among the plural fourth-propagation path responses hji of the fourth-propagation path response matrix H, and may correct, to zero, the fourth-propagation path response in which the calculated value of electric power of the fourth-propagation path response is equal to or less than a predetermined threshold value γth, or less than the threshold value γth, among the plural fourth-propagation path responses that are not set to zero in advance.

The weight calculation section 4122 calculates the inverse matrix H⁻¹ of the fourth-propagation path response matrix H, and calculates one or plural reception weights W to be applied to reception signals received by antennas of base stations of one or plural surrounding macro cells, based on the inverse matrix H⁻¹ of the fourth-propagation path response matrix and the third-propagation path response matrix h.

For example, the weight calculation section 4122 calculates the inverse matrix H⁻¹ of the fourth-propagation path response matrix H, and calculates plural reception weights Wi to be applied to reception signals received by the antennas 21 of the base stations 20(i) of plural surrounding macro cells, based on the inverse matrix H⁻¹ of the fourth-propagation path response matrix and the third-propagation path response matrix h.

The reception-signal processing section 4123 suppresses the interference to the uplink of the base station of the target macro cell from one or plural terminals located in the one or plural surrounding macro cells, based on the reception signal received by the antenna of the base station of the target macro cell, plural reception signals received by the antennas of the base stations of one or plural surrounding macro cells, and the one or plural reception weights.

For example, the reception-signal processing section 4123 suppresses the interference from terminals 10(i−1) of plural surrounding macro cells to the uplink of the target macro-cell base station 20, based on the reception signal X(0) received by the antenna 21 of the target macro-cell base station 20, plural reception signals X(i) received by the antennas 21 of the base stations 20(i) of plural surrounding macro cells, and plural reception weights Wi.

As described above, according to the present embodiment, in the configuration in which the HetNet 1S, in which one or plural small cells 300 are disposed in the macro cell 200, is disposed in a cellular manner, it is possible to suppress the interference from the terminal 10 located in the small cell 300 to the uplink reception signal received by the antenna 21 of the macro-cell base station 20 in the HetNet 1S, and it is also possible to suppress the interference from the terminal 10 located in the macro cell 200 of the surrounding HetNet 1S to the uplink reception signal received by the antenna 21 of the macro-cell base station 20 in the HetNet 1S.

Moreover, according to the present embodiment, it is possible to reduce the amount of signal processing required for calculating the reception weights to suppress the interference, and to reduce the number of measurements of the second-propagation path response across the entire cell that is required for the calculation.

The present invention can provide a system capable of suppressing the macro-cell uplink reception interference in a configuration in which plural HetNets are arranged in a cellular manner and one or plural small cells are disposed within a macro cell in each HetNet, so it is possible to contribute to achieving Goal 9 of the Sustainable Development Goals (SDGs), which is to “Create a foundation for industry and technological innovation”.

It is noted that, the process steps and configuration elements of the system, the interference suppression apparatus, the radio apparatus, the base station, the radio relay station (feeder station) and the terminal (user apparatus, mobile station, mobile machine) described in the present description can be implemented with various means. For example, these process steps and configuration elements may be implemented with hardware, firmware, software, or a combination thereof.

With respect to hardware implementation, means such as processing units or the like used for establishing the foregoing steps and configuration elements in entities (for example, various kinds of radio communication apparatuses, radio relay apparatus, Node B, server, gateway, exchange machine, computer, hard disk drive apparatus, or optical disk drive apparatus) may be implemented in one or more of an application-specific IC (ASIC), a digital signal processor (DSP), a digital signal processing apparatus (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means for using to establish the foregoing configuration elements may be implemented with a program (for example, code such as procedure, function, module, instruction, etc.) for performing a function described in the present specification. In general, any computer/processor readable medium of materializing the code of firmware and/or software may be used for implementation of means such as processing units and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage unit, or the like. The code may be executed by one or more of computers and processors, and a certain aspect of functionalities described in the present specification may by executed by a computer or processor.

The medium may be a non-transitory recording medium. Further, the code of the program may be executable by being read by a computer, a processor, or another device or an apparatus machine, and the format is not limited to a specific format. For example, the code of the program may be any of a source code, an object code, and a binary code, and may be a mixture of two or more of those codes.

The description of embodiments disclosed in the present specification is provided so that the present disclosures can be produced or used by those skilled in the art. Various modifications of the present disclosures are readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: terminal
20: macro-cell base station
20(1): central macro-cell base station
20(2), 20(2): surrounding macro-cell base station
21: antenna
30: small-cell base station
31: antenna
40: centralized BBU
50: communication line
200: macro cell
300: small cell
400: cooperative control network
401(1) to 401(3): first-stage cooperative control network
402: second-stage cooperative control network
410: interference suppression apparatus
411(1) to 411(3): first-stage interference suppression apparatus
4111: matrix creation section
4112: weight calculation section
4113: reception-signal processing section
412: second-stage interference suppression apparatus
4121: matrix creation section
4122: weight calculation section
4123: reception-signal processing section
420: receiver
421(1) to 421(3): first stage receiver
430: receiver

1. A system for suppressing an interference from a terminal to a base station in a plural-HetNet configuration in which plural HetNets (heterogeneous networks) using a same frequency band including a first cell formed by a first base station and one or plural second cells formed in the first cell by one or plural second base stations are disposed in a cellular manner, comprising:
a plurality of first-stage interference suppression apparatuses that suppress an uplink interference signal from a terminal located in the second cell to an uplink reception signal of the first base station of the first cell of the HetNet, in each of the plural HetNets; and
a second-stage interference suppression apparatus that suppresses an uplink interference signal to an uplink reception signal of a first base station in a first cell of one HetNet after performing the suppression of the interference signal by the first-stage interference suppression apparatus, from a terminal located in a first cell of other HetNet, with respect to each of the plural HetNets.

2. The system according to claim 1,
wherein each of the plurality of the first-stage interference suppression apparatuses comprises:
a first-stage matrix creation section that estimates a first-propagation path response from the terminal located in the second cell to an antenna of the first base station of the first cell, creates a first-propagation path response matrix including the first-propagation path response as an element, estimates a second-propagation path response from the terminal located in the second cell to an antenna of the second base station of the second cell, and creates a second-propagation path response matrix including the second-propagation path response as an element;
a first-stage weight calculation section that calculates an inverse matrix of the second-propagation path response matrix, and calculates a first-stage reception weight to be applied to a reception signal received by the antenna of the second base station of the second cell, based on the inverse matrix of the second-propagation path response matrix and the first-propagation path response matrix; and
a first-stage reception signal processing section that suppresses an interference of the uplink interference signal from the terminal located in the second cell to the uplink reception signal of the first base station of the first cell, based on the reception signal received by the antenna of the first base station of the first cell, the plural reception signals received by the antenna of the second base station of the second cell, and the first-stage reception weight; and
wherein the second-stage interference suppression apparatus comprises:
a second-stage matrix creation section that estimates a third-propagation path response from the terminal located in the first cell of the other HetNet to the antenna of the first base station of the first cell of the one HetNet, creates a third-propagation path response matrix including the third-propagation path response as an element, estimates a fourth-propagation path response from the terminal located in the first cell of the other HetNet to the antenna of the first base station of the first cell of the other HetNet, and creates a fourth-propagation path response matrix including the fourth-propagation path response as an element;
a second-stage weight calculation section that calculates an inverse matrix of the fourth-propagation path response matrix, and calculates a second-stage reception weight to be applied to the reception signal received by the antenna of the first base station of the first cell of the other HetNet, based on the inverse matrix of the fourth-propagation path response matrix and the third-propagation path response matrix; and
a second-stage reception signal processing section that suppresses an interference of the uplink interference signal from the terminal located in the first cell of the other HetNet to the uplink reception signal of the first base station of the first cell of the one HetNet, based on the reception signal received by the antenna of the first base station of the first cell of the one HetNet, the reception signal received by the antenna of the first base station of the first cell of the other HetNet, and the second-stage reception weight.

3. The system according to claim 2,
wherein the number of the HetNets is 2 or more, and
wherein the second-stage matrix creation section sets to zero a fourth-propagation path response having an electric power of magnitude equal to or less than a predetermined threshold value, or less than the threshold value, among the plural fourth-propagation path responses included in the fourth-propagation path response matrix before calculating the inverse matrix.

4. The system according to claim 3,
wherein the second-stage matrix creation section:
calculates the electric power of each of the plural fourth-propagation path responses included in the fourth-propagation path response matrix before calculating the inverse matrix; and
corrects to zero a fourth propagation path response in which the calculated value of the electric power is equal to or less than a predetermined threshold value γₜₕ, or less than the threshold value γₜₕ.

5. The system according to claim 3,
wherein the system sets to zero in advance a fourth-propagation path response that is expected to have a small contribution to the interference among the plural fourth-propagation path responses of the fourth-propagation path response matrix created by the second-stage matrix creation section, and
wherein the second-stage matrix creation section:
does not estimate the fourth-propagation path response that is set to zero in advance among the plural fourth-propagation path responses of the fourth-propagation path response matrix; and
corrects to zero a fourth-propagation path response in which the calculated value of the electric power of the fourth-propagation path response is equal to or less than a predetermined threshold value Γₜₕ, or less than the threshold value Γₜₕ, among the plural fourth-propagation path responses that are not set to zero in advance.

6. The system according to claim 3,
wherein the system sets to zero in advance a fourth-propagation path response that is expected to have a small contribution to the interference among the plural fourth-propagation path responses of the fourth-propagation path response matrix created by the second-stage matrix creation section, and
wherein the second-stage matrix creation section does not estimate the fourth-propagation path response that is set to zero in advance among the plural fourth-propagation path responses of the fourth-propagation path response matrix.

7. The system according to claim 6,
wherein the system estimates the plural fourth-propagation path responses before starting an operation of plural first base stations in the plural-HetNet configuration, and sets to zero a fourth-propagation path response in which the calculated value of the electric power of the fourth-propagation path response is equal to or less than the predetermined threshold value Γₜₕ, or less than the threshold value Γₜₕ, among the plural fourth-propagation path responses.

8. The system according to claim 6,
wherein the system determines a fourth-propagation path response to be set to zero in advance, based on a positional relationship between the plural first base stations or a positional relationship between plural first cells of the plural first base stations in the plural HetNets.

9. The system according to claim 1,
wherein the system does not suppress the interference signal by the first-stage interference suppression apparatus, when the electric power of the uplink interference signal from the terminal located in the second cell to the uplink reception signal of the first base station of the first cell of the HetNet is equal to or less than a predetermined threshold value, or less than the threshold value, in each of the plural HetNets.

10. The system according to claim 2,
wherein the system does not suppress the interference signal by the first-stage interference suppression apparatus, when the electric power of the uplink interference signal from the terminal located in the second cell to the uplink reception signal of the first base station of the first cell of the HetNet is equal to or less than a predetermined threshold value, or less than the threshold value, in each of the plural HetNets.

11. The system according to claim 3,
wherein the system does not suppress the interference signal by the first-stage interference suppression apparatus, when the electric power of the uplink interference signal from the terminal located in the second cell to the uplink reception signal of the first base station of the first cell of the HetNet is equal to or less than a predetermined threshold value, or less than the threshold value, in each of the plural HetNets.

12. The system according to claim 4,
wherein the system does not suppress the interference signal by the first-stage interference suppression apparatus, when the electric power of the uplink interference signal from the terminal located in the second cell to the uplink reception signal of the first base station of the first cell of the HetNet is equal to or less than a predetermined threshold value, or less than the threshold value, in each of the plural HetNets.

13. The system according to claim 5,
wherein the system does not suppress the interference signal by the first-stage interference suppression apparatus, when the electric power of the uplink interference signal from the terminal located in the second cell to the uplink reception signal of the first base station of the first cell of the HetNet is equal to or less than a predetermined threshold value, or less than the threshold value, in each of the plural HetNets.

14. The system according to claim 6,
wherein the system does not suppress the interference signal by the first-stage interference suppression apparatus, when the electric power of the uplink interference signal from the terminal located in the second cell to the uplink reception signal of the first base station of the first cell of the HetNet is equal to or less than a predetermined threshold value, or less than the threshold value, in each of the plural HetNets.

15. The system according to claim 7,
wherein the system does not suppress the interference signal by the first-stage interference suppression apparatus, when the electric power of the uplink interference signal from the terminal located in the second cell to the uplink reception signal of the first base station of the first cell of the HetNet is equal to or less than a predetermined threshold value, or less than the threshold value, in each of the plural HetNets.

16. The system according to claim 8,
wherein the system does not suppress the interference signal by the first-stage interference suppression apparatus, when the electric power of the uplink interference signal from the terminal located in the second cell to the uplink reception signal of the first base station of the first cell of the HetNet is equal to or less than a predetermined threshold value, or less than the threshold value, in each of the plural HetNets.
